(19) United States
(12) Patent Application Publication
(10) Pub. No.: US 2019/0014137 A1
(43) Pub. Date: Jan. 10, 2019

(54) IoT DEVICE SECURITY

(71) Applicant: ZingBox, Inc., Mountain View, CA (US)

(72) Inventors: Jun Du, Cupertino, CA (US); Mei Wang, Saratoga, CA (US); Ran Xia, Campbell, CA (US); Zhiwei Xiao, Palo Alto, CA (US)

(21) Appl. No.: 15/948,931

(22) Filed: Apr. 9, 2018

Related U.S. Application Data
(60) Provisional application No. 62/530,773, filed on Jul. 10, 2017.

(51) Int. Cl. H04L 29/06; G06N 3/04; G06N 3/08; G06F 17/30

(52) U.S. Cl. CPC H04L 63/1425; G06N 3/0427; H04L 63/20; G06F 17/30598; G06F 17/30374; G06N 3/08

(57) ABSTRACT

Techniques for providing Internet of Things (IoT) device security are disclosed. An applicable system includes IoT devices coupled to an evolving context-aware IoT device security system. In a specific implementation, the system uses common factor aggregation of event parameters to determine IoT device personality.

### CROSS-REFERENCE TO RELATED APPLICATIONS

This application claims priority to U.S. Provisional Patent Application No. 62/530,773, filed Jul. 10, 2017, which is incorporated by reference herein.

### BRIEF DESCRIPTION OF THE DRAWINGS

FIG. 1 depicts a diagram of an example of a system for providing evolving context-aware Internet of Things (IoT) device security.

FIG. 2 depicts a flowchart of an example of a method for determining undesired behavior in operation of an IoT device.

FIG. 3 depicts a diagram of an example context aware IoT event aggregation system.

FIG. 4 depicts a flowchart of an example of a method for aggregating events occurring at an IoT device based on context for purposes of detecting undesired behavior in the operation of the IoT device.

FIG. 5 depicts a diagram of an example context-based IoT device undesired behavior detection system.

FIG. 6 depicts a flowchart of an example of a method for detecting undesired behavior in operation of an IoT device using aggregated events occurring in the operation of the IoT device.

FIG. 7 depicts a diagram of an example context-based undesired behavior detection model maintenance system.

FIG. 8 depicts a diagram of an example of a system for determining undesired behavior of IoT devices in operation.

FIG. 9 depicts a diagram of another example of a system for identifying undesired behavior in operation of an IoT device.

FIG. 10 depicts a diagram of an example of a system for determining undesired behavior of IoT devices in operation.

FIG. 11 depicts a diagram of another example of a system for identifying undesired behavior in operation of an IoT device.

FIG. 12 depicts a diagram of another example of a system for determining undesired behavior in operation of an IoT device.

FIG. 13 depicts a diagram of an example of a system for detecting undesired behavior in IoT device operation through a mirror point.

FIG. 14 depicts a flowchart of an example of a method for maintaining a context-based undesired behavior detection model for use in determining undesired behavior in operation of an IoT device.

FIG. 15 depicts a diagram of an example of a IoT device personality management system.

FIG. 16 depicts a flowchart of an example of a method of IoT device personality management.

### DETAILED DESCRIPTION

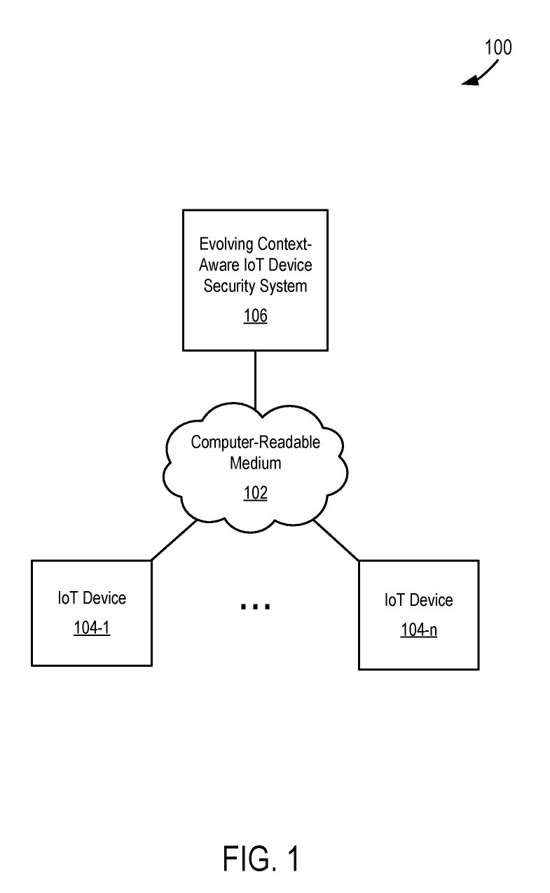

FIG. 1 depicts a diagram 100 of an example of a system for providing context-aware Internet of Things (IoT) device security. The system of the example of FIG. 1 includes a computer-readable medium 102, IoT device 104-1 . . . 104-n (hereinafter referred to as “IoT devices 104”) coupled to the computer-readable medium 102, and an evolving context-aware IoT device security system 106.

The computer-readable medium 102 and other computer readable mediums discussed in this paper are intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 and other computer readable mediums discussed in this paper are intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

The devices, systems, and computer-readable mediums described in this paper can be implemented as a computer system or parts of a computer system or a plurality of computer systems. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. Depending upon implementation-specific or other considerations, the I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, ISDN modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to end user devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their end user device.

A computer system can be implemented as an engine, as part of an engine or through multiple engines. As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

Returning to the example of FIG. 1, the IoT devices 104 are intended to represent devices with wired or wireless interfaces through which the IoT devices 104 can send and receive data over wired and wireless connections. Examples of IoT devices include thermostats, mobile devices, biological managers, sensory devices, and functionality performing devices. The IoT devices 104 can include unique identifiers which can be used in the transmission of data through a network. Unique identifiers of the IoT devices 104 can include identifiers created in accordance with Internet Protocol version 4 (hereinafter referred to as “IPv4”), or identifiers created in accordance with Internet Protocol version 6 (hereinafter referred to as “IPv6”), of which both protocol versions are hereby incorporated by reference. Depending upon implementation-specific or other considerations, the IoT devices 104 can include applicable communication interfaces for receiving and sending data according to an applicable wireless device protocol. Examples of applicable wireless device protocols include Wi-Fi, ZigBee®, Bluetooth®, and other applicable low-power communication standards.

In a specific implementation, the IoT devices 104 act as stations. A station, as used in this paper, can be referred to as a device with a media access control (MAC) address and a physical layer (PHY) interface to a wireless medium that complies with the IEEE 802.11 standard. Thus, for example, the network devices can be referred to as stations, if applicable. IEEE 802.11a-1999, IEEE 802.11b-1999, IEEE 802.11g-2003, IEEE 802.11-2007, and IEEE 802.11n TGn Draft 8.0 (2009) are incorporated by reference. As used in this paper, a system that is 802.11 standards-compatible or 802.11 standards-compliant complies with at least some of one or more of the incorporated documents' requirements and/or recommendations, or requirements and/or recommendations from earlier drafts of the documents, and includes Wi-Fi systems. Wi-Fi is a non-technical description that is generally correlated with the IEEE 802.11 standards, as well as Wi-Fi Protected Access (WPA) and WPA2 security standards, and the Extensible Authentication Protocol (EAP) standard. In alternative embodiments, a station may comply with a different standard than Wi-Fi or IEEE 802.11, may be referred to as something other than a “station,” and may have different interfaces to a wireless or other medium.

In a specific implementation, the IoT devices 104 are configured to access network services in compliance with IEEE 802.3. IEEE 802.3 is a working group and a collection of IEEE standards produced by the working group defining the physical layer and data link layer's MAC of wired Ethernet. This is generally a local area network technology with some wide area network applications. Physical connections are typically made between nodes and/or infrastructure devices (hubs, switches, routers) by various types of copper or fiber cable. IEEE 802.3 is a technology that supports the IEEE 802.1 network architecture. As is well-known in the relevant art, IEEE 802.11 is a working group and collection of standards for implementing wireless local area network (WLAN) computer communication in the 2.4, 3.6 and 5 GHz frequency bands. The base version of the standard IEEE 802.11-2007 has had subsequent amendments. These standards provide the basis for wireless network products using the Wi-Fi brand. IEEE 802.1 and 802.3 are incorporated by reference.

In a specific implementation, the IoT devices 104 are purposefully built or configured IoT devices. In being purposely built IoT devices, the IoT devices 104 are built to have specific operational parameters. For example, a thermometer may be built to provide signals from a temperature sensor. In being purposely configured IoT devices, the IoT devices 104 can be configured to operate according to specific operational parameters in accordance with input from a human or artificial agent. For example, an IoT device of the IoT devices 104 can be a thermostat configured to control an air conditioner to cool a room to a configurable temperature at a configurable time. As another example, an agent can specify an IoT device should not communicate with a specific data source, and the IoT device can be configured to refrain from communicating with the specific data source as part of purposeful configuration.

In the example system 100 shown in FIG. 1, the evolving context-aware IoT device security system 106 is intended to represent a system that understands domain-specific context and uses machine learning to generate additional domain knowledge. A context of an IoT device, as used herein, includes IoT device profiles, IoT device categories, applicable operational parameters of an IoT device in operation, to name a few. For example, an IoT can be profiled as a thermostat, categorized as a General Electric product, and context can include an ID of an IoT device, sources (or paths) of messages to the IoT device, destinations (or paths) of messages from the IoT device, current operational parameters of the IoT device, e.g. how an IoT device operates in controlling itself, behaviors of an IoT device in operation, whether an IoT device is actually operating, data ports used by an IoT device in sending and receiving data, types of data sent or received, operating systems used by an IoT device, and applications used by an IoT device. Further, a context of an IoT device can include applicable operational parameters of an IoT device in operation to either or both access network services and broadcast. For example, a context of an IoT device can include a message an IoT device broadcasts in acting as a beacon. In another example, a context of an IoT device can include a data source with which an IoT device communicates through a WAN.

In a specific implementation, at least a portion of the evolving context-aware IoT device security system 106 is implemented remote relative to IoT devices for which the system determines risk levels. For example, at least a portion of the evolving context-aware IoT device security system 106 can be implemented as cloud based systems. Portions of the evolving context-aware IoT device security system 106 implemented remote relative to IoT devices can receive data associated with the IoT devices through virtual private network (hereinafter “VPN”) tunnels. For example, the evolving context-aware IoT device security system 106 can receive outbound network traffic sent from IoT devices over a VPN tunnel. Additionally, VPN tunnels through which the evolving context-aware IoT device security system 106 can send and receive data can be maintained using dedicated networking equipment. For example, the evolving context-aware IoT device security system 106 can receive data associated with the IoT devices using dedicated routers for communicating with the IoT devices.

Instead or in addition, at least a portion of the evolving context-aware IoT device security system 106 can be implemented through a mirror in a gateway, one or more local agents, or on one or more IoT devices; intelligence can be distributed. A local agent includes software implemented on a physical device locally coupled to IoT devices. Local coupling involves operationally connecting the local agent via a LAN interface (or a smaller network interface, such as a PAN interface) to IoT devices. It should be noted enterprise networks can include geographically distributed LANs coupled across WAN segments. In a distributed enterprise network, the local agents may be local at each LAN (each LAN is sometimes referred to as a Basic Service Set (BSS) in IEEE 802.11 parlance, though no explicit requirement is suggested here) or localized using, e.g., VLAN tunneling (the connected LANs are sometimes referred to as an Extended Service Set (ESS) in IEEE 802.11 parlance, though no explicit requirement is suggested here). Depending upon implementation-specific or other considerations, the evolving context-aware IoT device security system 106 can include wired communication interfaces and wireless communication interfaces for communicating over wired or wireless communication channels. The evolving context-aware IoT device security system 106 can be, at least in part, a device provided by an Internet service provider directly purchased by a consumer and acting as a conduit between networks. Depending upon implementation or other considerations, the evolving context-aware IoT device security system 106 can be implemented as part of a private cloud. A private cloud implementing the evolving context-aware IoT device security system 106, at least in part, can be specific to an entity.

In a specific implementation, the evolving context-aware IoT device security system 106 functions to determine undesired behavior in IoT device operation, otherwise abnormal IoT device behavior in operation, based on events. Undesired behavior is defined by an institutional or security system as undesirable. It may be noted that an IoT device with a good personality can exhibit anomalous behavior and still be considered to have a good personality while an IoT device with a bad personality need not exhibit anomalous behavior and still be considered to have a bad personality. This is made of note because techniques used to identify undesired behavior can include anomaly detection, but anomaly detection is not the universe of undesired behavior detection. As used in this paper, a personality includes mathematically modelled behavior patterns, with institutional knowledge built into the personality model. Examples of bad personality include behavior associated with bots, C&C centers (botnet), or servers taken over by malware, to name three, all of which can have recognizable behaviors.

In a specific implementation, the evolving context-aware IoT device security system 106 can determine events based on messages transmitted by (or to) an IoT device. For example, the evolving context-aware IoT device security system 106 can translate one or a plurality data packets transmitted by (or to) an IoT device into events which can subsequently be used to determine whether the IoT device is behaving appropriately for the IoT device's given context. As another example, the evolving context-aware IoT device security system 106 can correlate one or a plurality of data packets transmitted by (or to) an IoT device to an event of a specific application being executed on the IoT device. Events can be associated with a specific context of an IoT device, such as having a specific operating system executing on an IoT device or being controlled by a specific user.

In a specific implementation, the evolving context-aware IoT device security system 106 functions to determine events locally with respect to IoT devices. In determining events locally with respect to IoT devices, the evolving context-aware IoT device security system 106 can be implemented at a device within a LAN associated with or formed in part through the IoT device. Further, the evolving context-aware IoT device security system 106 can locally determine at a device within a LAN events for use in determining an IoT device operation is in appropriate in the IoT device's current context. For example, the evolving context-aware IoT device security system 106 can be implemented at a local agent and determine at the local agent events for use in detecting undesired behavior in IoT device operation relative to the IoT device's historical operation, relative to other similarly classified IoT devices' operations, relative to similarly profiled IoT devices' operation, etc.

In a specific implementation, the evolving context-aware IoT device security system 106 identifies event parameters (data or metadata) by analyzing the data packets. For example, if a data packet can be correlated with a specific application, then the evolving context-aware IoT device security system 106 can identify an event parameter of the specific application is executed in association with an IoT device. The evolving context-aware IoT device security system 106 can use packet header analysis to identify event parameters from data packets transmitted to or from an IoT device. Additionally, the evolving context-aware IoT device security system 106 can use deep packet inspection to identify event parameters from data packets. For example, the evolving context-aware IoT device security system 106 can use deep packet inspection to analyze a payload of a data packet sent from an IoT device and subsequently identify an event parameter from the data packet.

In a specific implementation, the evolving context-aware IoT device security system 106 determines one or a combination of device sensor events, session events, application events, user events, protocol events, and status events included as part of a context of an IoT device in operation. Device sensor events can include events that occur at the physical layer of the physical layer or data link layer of the open system interconnection (hereinafter referred to as “OSI”) model. For example, device sensor events can include a virtual LAN (hereinafter referred to as “VLAN”) used by an IoT device to communicate with a specific data source. Session events can include events that occur at either the network layer or the transport layer of the OSI model. For example, session events can include a specific network type used by an IoT device to communicate with a source. Application events include events that occur at one or a combination of the session layer, the presentation layer, and the application layer of the OSI model. For example, application events can include an identification of an application executed at an IoT device in accessing network services. Device events can include events that occur at a specific device. User events can include events that occur in associated with a specific user interacting with an IoT device. For example, user events can include specific instances in which a specific user interacts with IoT devices. Status events can include events associated with whether an IoT device is operating. For example, status events can include an event indicating whether an IoT device is operating within a given operational efficiency range.

In a specific implementation, the evolving context-aware IoT device security system 106 functions to determine analytics features of IoT devices in operation. An analytics feature is a transformation of one or more timestamped events, including composite events. As used in this paper, a composite event comprises multiple event parameters, but is referred to as an “event,” which is a more general term intended to represent a discrete event or a combination of event parameters (which can include one or more discrete events). For example, a discrete event, such as a signal transmitted from a thermometer associated with a discrete temperature sensing instance, can be combined with an event parameters for the destination of the signal, historical signal transmissions, transmissions of similarly classified IoT devices, and the like, to generate a composite event. The evolving context-aware IoT device security system 106 can determine analytics features of IoT devices in operation based on messages transmitted to or from IoT devices. For example, the evolving context-aware IoT device security system 106 can examine messages transmitted to an IoT device to determine an event which can subsequently be timestamped to create an analytics feature of the IoT device in operation. The evolving context-aware IoT device security system 106 can generate analytics features of IoT devices in operation within a time window. For example, the evolving context-aware IoT device security system 106 can examine all messages transmitted from an IoT device within a one hour period to determine a feature of the IoT device in operation. A time window, also referred to as a data rollup window, used by the evolving context-aware IoT device security system 106 to generate features of an IoT device in operation. For example, the evolving context-aware IoT device security system 106 can examine packets transmitted from a first IoT device over a 24 hour period and examine packets transmitted from a second IoT device over a five minute period to extract features of the first and second IoT devices in operation. A time window used by the evolving context-aware IoT device security system 106 to extract features of IoT devices in operation can vary based on contexts of the IoT devices. For example, the evolving context-aware IoT device security system 106 can vary time windows used to extract features of IoT devices in operation based on device types of the IoT devices.

In a specific implementation, the evolving context-aware IoT device security system 106 functions to aggregate determined events for purposes of determining undesired behavior in IoT device operation. The evolving context-aware IoT device security system 106 can aggregate events based on context, such as by way of a profile-based aggregation. For example, the evolving context-aware IoT device security system 106 can aggregate events based on recipients of data packets transmitted from an IoT device. In another example, the evolving context-aware IoT device security system 106 can aggregate events based on an IoT device ID or a port used transmit data packets from which the events are translated. Further, the evolving context-aware IoT device security system 106 can aggregate events based on contexts associated with events. For example, the evolving context-aware IoT device security system 106 can aggregate events based on whether the events are one or a combination of device sensor events, session events, application events, user events, protocol events, and status events.

In a specific implementation, the evolving context-aware IoT device security system 106 can aggregate events of IoT devices in operation using common factor aggregation machine learning. Common factor aggregation creates various aggregations and transformations from the incoming data events leveraging on supervised classification, unsupervised clustering-based machine learning, and multi-layer deep learning to model various behavior patterns of IoT devices so the IoT devices can be grouped/labelled based on their behaviors. For example, an ultrasound machine running windows OS and connecting to its home servers in Europe would be tagged with, in this example, 2 different behavior aggregation factors and the correlation of these behaviors can help accurately identify the device as an ultrasound machine of a specific model.

In a specific implementation, the evolving context-aware IoT device security system 106 can aggregate events of IoT devices in operation using common factor aggregation machine learning. For example, if, through machine learning, common factors of an IoT device being hacked are identified, then the evolving context-aware IoT device security system 106 can group events of IoT devices being hacked based on the common factors identified through machine learning. Alternatively or in addition, the evolving context-aware IoT device security system 106 can use common factor aggregation machine learning to identify common factors of contexts of IoT devices in operation, for use in aggregating events based on context. For example, if events related to operation of IoT devices by a particular user share a specific common factor, identified through machine learning, then the evolving context-aware IoT device security system 106 can group events of the user operating IoT devices together based on the specific common factor.

To allow comparison of events for common factor aggregation, a harmonized framework of events (e.g., a common methodological framework) is desirable, which can be implemented as a huge amount of data that is analyzed for commonalities. The analysis takes more or less work depending upon the type of data (e.g., comparing sources and destinations is relatively straight-forward, while comparing values identified using deep packet inspection of payload is relatively less straight-forward). Reducing factors to a common baseline is impractical due to the number of different aggregations that are relevant in an IoT network comprising a large number of devices; reduction to a common baseline is useless for predictive purposes. Multiple aggregations are necessary and may not even be easily identifiable to a human because the common factors are not easily categorized by the human mind and, due to their numbers, will, in practice, likely go without human-understandable aggregations of common factors. Indeed, it is a hopeless task for a human given the number and frequency of communications IoT networks are already generating, even if all of the aggregations were uniquely describable to a human. So a computer must be used to find the large number of common factors necessary to yield predictable, and therefore actionable, intelligence; humans can, of course, help in categorization or other tasks after being augmented by the computer.

In a specific implementation, the evolving context-aware IoT device security system 106 functions to drop specific determined features or events from consideration in determining whether an IoT device is operating in an undesirable manner. In dropping specific features from consideration in determining whether an IoT device behavior is undesirable, the evolving context-aware IoT device security system 106 can filter out irrelevant factors to only keep IoT compatible features for purposes of determining whether the IoT device behavior is undesirable. For example, the evolving context-aware IoT device security system 106 can filter out features associated with human factors in IoT device operation for purposes of determining whether the IoT device behavior is undesirable.

In a specific implementation, the evolving context-aware IoT device security system 106 functions to filter out features for use in detecting undesired device behavior based on either or both a personality of an IoT device and a profile of a group of IoT devices including the IoT device. A personality of an IoT device includes applicable data describing operation of an IoT device for purposes of detecting undesired behavior of the IoT device in operation. For example, a personality of an IoT device can include normal operating behavior patterns of an IoT device and undesired operating behavior patterns of an IoT device. A profile of a group of IoT devices includes application data describing operation of IoT devices in the group for purposes of detecting undesired behavior of the IoT devices in operation. For example, a profile of a group of IoT devices can include normal operating behavior patterns of IoT devices in the group and undesired operating behavior patterns of the IoT devices in the group. IoT devices can be grouped together to form a profile, based on one or a combination of characteristics of the IoT devices, operational characteristics of the IoT devices, and contexts of the IoT devices in operation. For example, all thermostat IoT devices of a specific manufacturer can be grouped together to form a profile. In filtering out features for use in detecting undesired device behavior based on either or both a personality of an IoT device and a profile of a group of IoT devices, the evolving context-aware IoT device security system 106 can filter out normal operating behaviors of the IoT device of the group of IoT devices using the personality of profile.

In a specific implementation, the evolving context-aware IoT device security system 106 functions to add aggregated events and features into an event buffer. An event buffer includes a collection of events and features that are held for a period of time and analyzed to determine whether an IoT device is exhibiting undesired behavior in operation. An event buffer can be specific to a context associated with an IoT device in operation. For example, an event buffer can be associated with or specific to an application and can be used to determine whether an IoT device is exhibiting undesired behavior in operation when the application is executing at the IoT device. In another example, an event buffer can be associated with IoT devices of a specific device type and can be used to determine whether an IoT device of the device type is exhibiting undesired behavior in operation. The evolving context-aware IoT device security system 106 can buffer aggregated events and features into event buffers based on contexts associated with aggregated events and features, e.g. contexts of an IoT device in operation. For example, the evolving context-aware IoT device security system 106 can buffer aggregated events and features into an event buffer based on whether the events are one or a combination of device sensor events, session events, application events, user events, protocol events, and status events.

In a specific implementation, the evolving context-aware IoT device security system 106 functions to determine undesired behavior in IoT device operation through application of a context-based undesired behavior detection model to events and features of an IoT device operating. A context-based undesired behavior detection model includes applicable data describing either or both normal and abnormal behavior patterns or portions of behavior patterns of one or a plurality of IoT devices in operation. Specifically, a context-based undesired behavior detection model can include a modeled set of features indicating all or a portion of a behavior pattern. For example, a context-based undesired behavior detection model can include a combination of behavior events each indicated by a single modeled feature to form a behavior pattern. A context-based undesired behavior detection model is specific to a context of an IoT device. For example, a context-based undesired behavior detection model can indicate normal behavior patterns of an IoT device in interacting with a specific remote system. In applying a context-based undesired behavior detection model to determine undesired behavior in IoT device operation, the evolving context-aware IoT device security system 106 can apply the model to compare current or past operating of an IoT device, e.g. indicated by aggregated events and features, with normal or abnormal behavior patterns indicated by the model. Subsequently, by comparing the current or past operating of the IoT device with normal or abnormal behavior patterns, the evolving context-aware IoT device security system 106 can determine undesired behavior in IoT device operation.

In a specific implementation, a context-based undesired behavior detection model is included as part of a personality of an IoT device or a profile of a group of IoT devices. For example, a context-based undesired behavior detection model can include normal behavior patterns of IoT devices manufactured by the same manufacturer. In another example, a context-based undesired behavior detection model can include normal behavior patterns of a specific IoT device when a streaming music application is executed on the IoT device.

In a specific implementation, the evolving context-aware IoT device security system 106 performs personality classification for IoT devices through application of a plurality of context-based undesired behavior detection models to events and features of IoT device operation. A behavior pattern of an IoT device can be represented by a plurality of context-based undesired behavior detection models. Accordingly, the evolving context-aware IoT device security system 106 can apply the plurality of context-based undesired behavior detection models to aggregated events and features of an IoT device in operation to determine IoT device personality. For example, if a first context-based undesired behavior detection model indicates a first aspect of a behavior pattern of an IoT device and a second context-based undesired behavior detection model indicate a second aspect of the behavior pattern of the IoT device, then the evolving context-aware IoT device security system 106 can apply both the first and second models to classify the IoT device as having a bad personality.

In a specific implementation, the evolving context-aware IoT device security system 106 functions to apply a context-based undesired behavior detection model to aggregated events and features of an IoT device collected in event buffers in IoT device personality classification. Advantageously, aggregation based on remote, per application, per IP, or other factors can be on a granular level. For example, the evolving context-aware IoT device security system 106 can apply a context-based undesired behavior detection model to aggregated events and features in a buffer, in an order of the events and features in the buffer. The evolving context-aware IoT device security system 106 can apply specific context-based undesired behavior detection models to events and features based on a specific event buffer in which the events and features are collected. For example, if aggregated events are in an event buffer associated with applications executing on an IoT device, then the evolving context-aware IoT device security system 106 can apply context-based undesired behavior detection models for IoT device personality classification when applications are executed at the IoT device. In another example, if aggregated events are in an event buffer associated with session events, then the evolving context-aware IoT device security system 106 can apply context-based undesired behavior detection models for IoT device personality classification at a network layer level.

In a specific implementation, the evolving context-aware IoT device security system 106 functions to apply a context-based undesired behavior detection model to aggregated events and features based on a context of an IoT device in operating to generate the events. For example, the evolving context-aware IoT device security system 106 can apply a context-based undesired behavior detection model to aggregated events based on a port used in communicating data packets used to determine the events. In applying a context-based undesired behavior detection model to aggregated events based on a context of an IoT device, the evolving context-aware IoT device security system 106 can apply a context-based undesired behavior detection model based on an undesired behavior detection model in which the events are buffered. For example, the evolving context-aware IoT device security system 106 can apply a context-based animal detection model for analyzing device events to events buffered into an event buffer associated with detecting undesired behavior in events that occur at a specific device layer.

In a specific implementation, the evolving context-aware IoT device security system 106 functions to maintain context-based undesired behavior detection models for use in detecting undesired behavior in IoT device operation. In maintaining a context-based undesired behavior detection model for use in detecting undesired behavior in IoT device operation, the evolving context-aware IoT device security system 106 can create and update a context-based undesired behavior detection model. For example, the evolving context-aware IoT device security system 106 can update a context-based undesired behavior detection model as an IoT device continues to operate. The evolving context-aware IoT device security system 106 can maintain a context-based undesired behavior detection model based on operation of an IoT device within a specific data window. For example, the evolving context-aware IoT device security system 106 can adjust a context-based undesired behavior detection model offline daily based on IoT device operation during the day.

In a specific implementation, the evolving context-aware IoT device security system 106 functions to maintain a context-based undesired behavior detection model based on events determined based on operation of one or a plurality of IoT devices. For example, the evolving context-aware IoT device security system 106 can maintain a context-based undesired behavior detection model based on feature values of events occurring during operation of an IoT device. Additionally, the evolving context-aware IoT device security system 106 can maintain a context-based undesired behavior detection model based on aggregated events occurring during operation of one or a plurality of IoT devices. For example, the evolving context-aware IoT device security system 106 can update a context-based undesired behavior detection model based on feature values of events during operation of one or a plurality of IoT devices. Further in the example, the evolving context-aware IoT device security system 106 can maintain the context-based undesired behavior detection model based on the feature values of the events aggregated together using common factor aggregation based on contexts of the one or a plurality of the IoT devices in operation.

In a specific implementation, the evolving context-aware IoT device security system 106 functions to determine behavior patterns of an IoT device in operation for use in maintaining a context-based undesired behavior detection model. The evolving context-aware IoT device security system 106 can determine behavior patterns of an IoT device in operation based on aggregated events of the IoT device in operation. For example, if an IoT device exchanges data with a source every night, as indicated by aggregated events of the IoT device in operation, then the evolving context-aware IoT device security system 106 can determine a behavior pattern of the IoT device is exchanges data with the source at night. The evolving context-aware IoT device security system 106 can use an applicable machine learning mechanism to determine a behavior pattern of an IoT device in operation.

In a specific implementation, the evolving context-aware IoT device security system 106 functions to maintain a context-based undesired behavior detection model based on contexts of one or a plurality of IoT devices in operation. Specifically, the evolving context-aware IoT device security system 106 can maintain a context-based undesired behavior detection model based on a context of an IoT device in operating to generate aggregated events used to maintain the model. For example, if aggregated events of the IoT device in operation a created when a specific application is executing, then the evolving context-aware IoT device security system 106 can associate a context-based undesired behavior detection model generated using the events with the specific application. Further in the example, the context-based undesired behavior detection model can be applied by the evolving context-aware IoT device security system 106 to aggregated events generated when the specific application is executing at the IoT device to determine undesired behavior in the operation of the IoT device.

In a specific implementation, the evolving context-aware IoT device security system 106 functions to maintain a context-based undesired behavior detection model as part of either or both a personality of an IoT device and a profile group of IoT devices. For example, the evolving context-aware IoT device security system 106 can maintain a context-based undesired behavior detection model based on operation of an IoT device and subsequently include the context-based undesired behavior detection model as part of a personality of the IoT device. In maintaining a context-based undesired behavior detection model as part of a profile group of IoT devices, the evolving context-aware IoT device security system 106 can group together the IoT devices based on context of the IoT devices in operation. For example, the evolving context-aware IoT device security system 106 can group together IoT devices of a specific type, e.g. a context, into a profile group and subsequently add context-based undesired behavior detection models generated based on operation of the IoT devices into the profile group of the IoT devices.

In an example of operation of the example system shown in FIG. 1, the evolving context-aware IoT device security system 106 identifies events of the IoT devices 104 in operation. In the example of operation of the example system shown in FIG. 1, the evolving context-aware IoT device security system 106 aggregates the events based on contexts of the IoT devices 104 in operation. Further, in the example of operation of the example system shown in FIG. 1, the evolving context-aware IoT device security system 106 buffers the aggregated events into an event buffer based on the contexts of the IoT devices 104 in operation. In the example of operation of the example system shown in FIG. 1, the evolving context-aware IoT device security system 106 determine behaviors of an IoT device of the IoT devices 104 in operation based on the aggregated events in the event buffer. Additionally, in the example of operation of the example system shown in FIG. 1, the evolving context-aware IoT device security system 106 applies a context-based undesired behavior detection model to the determined behaviors of the IoT device based on the event buffer to determine undesired behavior in the IoT device in operation.

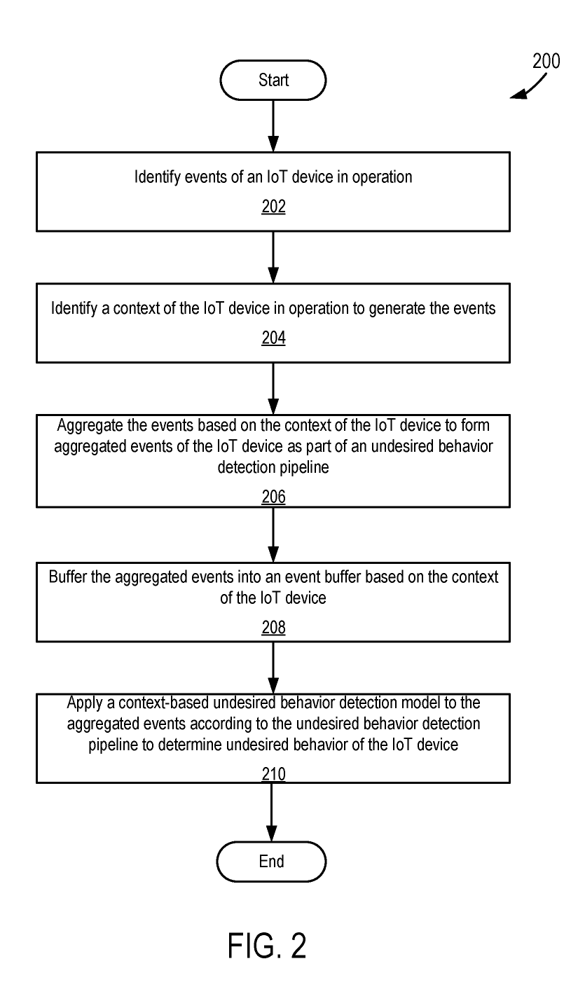

FIG. 2 depicts a flowchart 200 of an example of a method for determining undesired behavior in operation of an IoT device. The flowchart 200 begins at module 202, where events of an IoT device in operation are identified. An applicable system for detecting undesired behavior in operation of an IoT device based on context, such as the context aware IoT device undesired behavior detection systems described in this paper, can identify events of an IoT device in operation. Events of an IoT device in operation can be identified based on operation of an IoT device. For example, if an IoT device raises a temperature in a room by five degrees, then events indicating the IoT device has raised the temperature by five degrees can be identified. Additionally, events of an IoT device in operation can be identified based on messages transmitted to or from the IoT device. For example, an application executing at an IoT device can be determined by analyzing data packets transmitted to and from the IoT device during execution of the application at the IoT device.

The flowchart 200 continues to module 204, where a context of the IoT device in operation to generate the events is identified. An applicable system for detecting undesired behavior in operation of an IoT device based on context, such as the context aware IoT device undesired behavior detection systems described in this paper, can identify a context of the IoT device in operation to generate the events. For example, a device type of the IoT device can be determined including a context of the IoT device. A context of the IoT device in operation can be identified based on a flow of data to and from the IoT device. For example, deep packet inspection can be performed on messages transmitted to and from the IoT device to identify a context of the IoT device in operation.

The flowchart 200 continues to module 206, where the events are aggregated based on the context of the IoT device to form aggregated events of the IoT device. An applicable system for detecting undesired behavior in operation of an IoT device based on context, such as the context aware IoT device undesired behavior detection systems described in this paper, can aggregate the events based on the context of the IoT device to form aggregated events. The events can be aggregated to form aggregated events according to an applicable machine learning method. Common factor aggregation is a way to apply various different machine learning and deep learning algorithms by focusing on common factors (like all devices of same profile, same OS, using Windows, using telnet, all devices talking to a specific subnet, to name several) as applied to both detected and modeled behavior. For example, session events can be aggregate together. In another example, streaming events can be aggregated together. The events can be aggregated locally with respect to the IoT device. For example, the events can be aggregated to form the aggregated events by a device implemented as part of a LAN with the IoT device.

The flowchart 200 continues to module 208, where the aggregated events are buffered into an event buffer based on the context of the IoT device. An applicable system for detecting undesired behavior in operation of an IoT device based on context, such as the context aware IoT device undesired behavior detection systems described in this paper, can buffer the aggregated events into an event buffer based on the context of the IoT device. For example, if the aggregated events are session events, as indicated by the context of the IoT device, then the aggregated events can be buffered into an event buffer associated with analyzing session events to determine if IoT devices are exhibiting undesired behavior in operation.

The flowchart 200 continues to module 210, where a context-based undesired behavior detection model is applied to the aggregated events according to the undesired behavior detection pipeline to determine undesired behavior of the IoT device in operation. An applicable system for detecting undesired behavior in operation of an IoT device based on context, such as the context aware IoT device undesired behavior detection systems described in this paper, can apply a context-based undesired behavior detection model to the aggregated events according to the event buffer to determine undesired behavior of the IoT device in operation. For example, a behavior pattern of the IoT device can be determined from the aggregated events and the context-based undesired behavior detection model can be applied to the determined behavior pattern to identify whether undesired behavior of the IoT device in operation. Further in the example, the determined behavior pattern of the IoT device can be compared to normal behavior patterns of the IoT device or associated IoT devices, as indicated by the context-based undesired behavior detection model, to determine undesired behavior of the IoT device in operation. A context-based undesired behavior detection model applied to determine undesired behavior of the IoT device in operation can be included as part of either or both a personality of the IoT device and a profile of a group of IoT devices associated with the IoT device. For example, a context-based undesired behavior detection model can be included as part of a profile of a group of IoT devices including the IoT device that are all of the same device type.

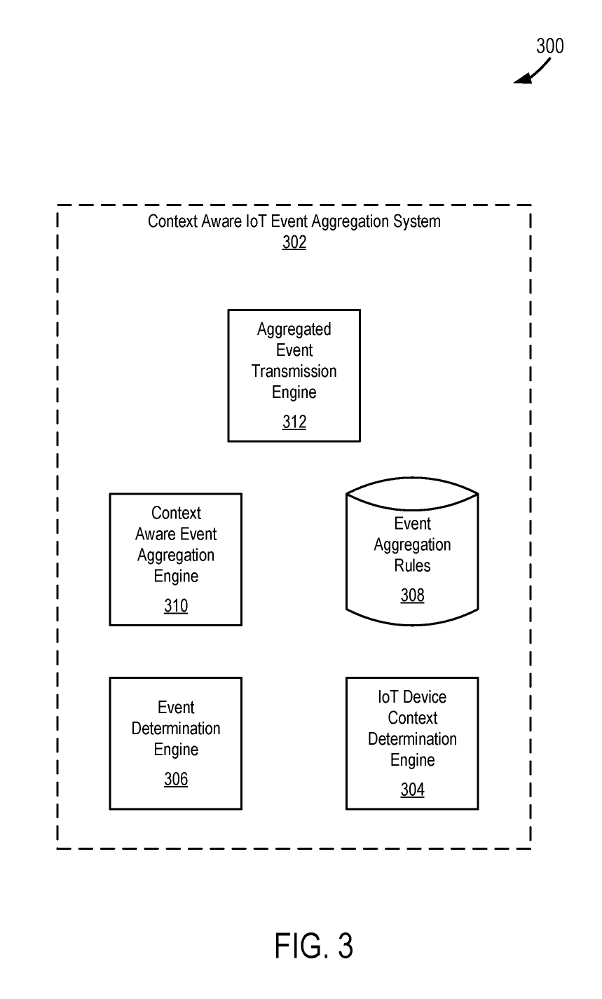

FIG. 3 depicts a diagram 300 of an example context aware IoT event aggregation system 302. The context aware IoT event aggregation system 302 is intended to represent a system that functions to aggregate events of an IoT device in operation for purposes of identifying undesired behavior of the IoT device in operation.

In a specific implementation, the evolving context-aware IoT device security system 106 generates event parameters from data packets while refraining from storing the data packets. Specifically, the evolving context-aware IoT device security system 106 can generate event metadata from data packets transmitted to and from an IoT device, without locally storing the actual data packets in non-volatile storage. The context aware IoT event aggregation system 302 can be included as part of an applicable system for detecting undesired behavior in operation of an IoT device based on context, such as the context aware IoT device undesired behavior detection systems described in this paper. Additionally, the context aware IoT event aggregation system 302 can be implemented locally with respect to one or a plurality of IoT devices. For example, the context aware IoT event aggregation system 302 can be implemented as a local device forming part of a LAN at a home of a plurality of IoT devices. Further in the example, the context aware IoT event aggregation system 302 can be implemented at a local device configured to provide the IoT devices access to network services through the LAN.

In aggregating events for purposes of detecting undesired behavior in IoT device operation, the context aware IoT event aggregation system 302 functions to determine events represented by event metadata for purposes of aggregating the events together. Further, the context aware IoT event aggregation system 302 can determine a context of an IoT device in operation for purposes of aggregating events together. For example, the context aware IoT event aggregation system 302 can determine a remote system an IoT device is communicating with and subsequently aggregate events associated with communications with the remote system for purposes of detecting undesired behavior in operation of the IoT device. Additionally, the context aware IoT event aggregation system 302 can provide event metadata of aggregated events to a remote system for purposes of detecting at the remote system undesired behavior in operation of an IoT device.

The example context aware IoT event aggregation system 302 shown in FIG. 3 includes an IoT device context determination engine 304, an event determination engine 306, an event aggregation rules datastore 308, a context aware event aggregation engine 310, and an aggregated event transmission engine 312. The IoT device context determination engine 304 is intended to represent an engine that functions to determine a context of an IoT device in operation for purposes of determining undesired behavior in the operation of the IoT device. The IoT device context determination engine 304 can determine a context of an IoT device in operation based on determined events in the operation of the IoT device. For example, the IoT device context determination engine 304 can determine an IoT device is communicating with another IoT device in operation. In determining a context of an IoT device based on determined events in the operation of the IoT device, the IoT device context determination engine 304 can determine a context of an IoT device with respect to the events. For example, the IoT device context determination engine 304 can determine a context of an IoT device at a time when it was operating to cause specific events to occur at the IoT device. The IoT device context determination engine 304 based on input received from a user. For example, a user can register a device as a thermostat manufactured by a specific manufacturer.

The event determination engine 306 is intended to represent an engine that functions to determine events in operation of an IoT device for purposes of determining undesired behavior in the operation of the IoT device. For example, the event determination engine 306 can determine a specific user is operating or otherwise interacting with an IoT device for purposes of detecting undesired behavior in the operation of the IoT device. In determining events in operation of an IoT device, the event determination engine 306 can determine how the IoT device is actually operating. For example, the event determination engine 306 can determine that lights in an office shut themselves off at a specific time. In determining events in operation of an IoT device, the event determination engine 306 can generate event metadata indicating the determined events. For example, the event determination engine 306 can generate event metadata indicating streaming events occurring at an IoT device.

In a specific implementation, the event determination engine 306 functions to determine events in operation of an IoT device by analyzing messages transmitted either or both to and from the IoT device. The event determination engine 306 can use an applicable packet inspection mechanism to analyze messages transmitted to and from an IoT device for purposes of determining events in operation of the IoT device. Specifically, the event determination engine 306 can analyze data packet headers to determine events in operation of an IoT device. For example, the event determination engine 306 can analyze headers of data packets transmitted to and from an IoT device to determine another IoT device communicating with the IoT device. Additionally, the event determination engine 306 can perform deep packets inspection on data packets transmitted to and from an IoT device to determine events in operation of the IoT device. For example, the event determination engine 306 can perform deep packet inspection to determine session events of an IoT device in operation.

The event aggregation rules datastore 308 is intended to represent a datastore that functions to store event aggregation rules data. Event aggregation rules data stored in the event aggregation rules datastore 308 includes data identifying applicable rules for aggregating events in the operation of IoT devices for use in detecting undesired behavior in the operation of the IoT devices. Event aggregation rules can be specific to contexts of IoT devices. For example, event aggregation rules can specify to aggregate streaming events occurring in the operation of an IoT device together. Further, event aggregation rules can specify common factors to use in aggregating events together. For example, event aggregation rules can specify to aggregate events of an IoT device communicating with a specific remote system, as indicated by a common factor. Event aggregation rules can be specific to a context of an IoT device in operation. For example, event aggregation rules can specify to aggregate all streaming events occurring at an IoT device together.

In a specific implementation, event aggregation rules indicated by event aggregation rules data stored in the event aggregation rules datastore 308 changes over time. Specifically, event aggregation rules can change over time based on observed behaviors of an IoT device in operation. For example, if an IoT device continues to operate according to specific process protocols, then event aggregation rules can specify aggregating events associated with IoT devices operating according to the specific process protocols. Additionally, event aggregation rules can change over time based on success in identifying undesired behavior in operation of IoT devices. For example, if streaming events aggregated together lead to better results in predicting undesired behavior in the operation of IoT devices, as determined through machine learning, then event aggregation rules can specify aggregating streaming events together. Further, event aggregation rules can be created and modified based on user input. For example, a user can specify to aggregate network layer events together for a specific type of IoT device, and event aggregation rules can subsequently be created and modified to indicate aggregating network layer events together for the specific type of IoT device.

The context aware event aggregation engine 310 is intended to represent an engine that functions to aggregate events together for purposes of detecting undesired behavior in the operation of IoT devices. In aggregating events together, the context aware event aggregation engine 310 can aggregate event metadata for aggregated events. For example, the context aware event aggregation engine 310 can aggregate event metadata of user events occurring in the operation of an IoT device. The context aware event aggregation engine 310 can aggregate events using common factor aggregation. Specifically, the context aware event aggregation engine 310 can identify common factors amongst events and subsequently aggregate the events together based on shared common factors. For example, the context aware event aggregation engine 310 can identify common factors amongst device sensor events and subsequently group together the device sensor events based on the shared common factors.

In a specific implementation, the context aware event aggregation engine 310 functions to aggregate events based on contexts of an IoT device in operation. More specifically, the context aware event aggregation engine 310 can aggregated events based on contexts of an IoT device associated with the events. For example, if a specific user was controlling operation of an IoT device when an IoT device was operating to cause the occurrence of specific events, then the context aware event aggregation engine 310 can aggregate the specific events together based on the fact they occurred when the specific user was operating the IoT device. In another example, if specific events occurred when an IoT device was communicating with a specific remote system, then the context aware event aggregation engine 310 can aggregate the specific events together based on the fact they occurred when the IoT device was communicating with the specific remote system.

In a specific implementation, the context aware event aggregation engine 310 can aggregate events according to event aggregation rules. For example, if event aggregation rules specify aggregating all session events of an IoT device in operation, then the context aware event aggregation engine 310 can aggregate all session events of the IoT device. In another example, if event aggregation rules specify aggregating events based on one or a combination of a device ID, a port number, and an IP address, then the context aware event aggregation engine 310 can aggregate events based on one or a combination of the device ID, the port number, and the IP address.

In a specific implementation, the context aware event aggregation engine 310 functions to aggregate events within a time window, otherwise referred to as a data rollup window. For example, the context aware event aggregation engine 310 can aggregate events over a 24 hour time period. In another example, the context aware event aggregation engine 310 can aggregate events over a week long time period. In aggregating events over a longer time period, e.g. a day or a week, undesired behavior in the operation of IoT devices that are normally inactive can still be detected. A data rollup window in which the context aware event aggregation engine 310 aggregates events can vary. For example, a data rollup window can vary on a per-device, per-user, and a per-device type basis. Additionally, a data rollup window in which the context aware event aggregation engine 310 aggregated events can vary based on a context of an IoT device in operation. For example, a data rollup window in which the context aware event aggregation engine 310 aggregated events can decrease in size as an IoT device becomes more active.

In a specific implementation, the context aware event aggregation engine 310 aggregates events within a short data rollup window. A short data rollup window is a time window between one and five minutes. In aggregating events over a short data rollup window, the context aware event aggregation engine 310 can aggregate events from port scans that occur every minute. Further, in aggregating events over a short data rollup window, persistent DDOS attacks can be observed as they persistently appear in the events aggregated by the context aware event aggregation engine 310 in the short data rollup window.

In a specific implementation, the context aware event aggregation engine 310 functions to filter out events for purposes of detecting undesired behavior in IoT device operation. In filtering out events for purposes of detecting undesired behavior in IoT device operation, the context aware event aggregation engine 310 can filter out irrelevant features to determining undesired behavior in the operation of the IoT device. For example, the context aware event aggregation engine 310 can filter out features associated with human factors in IoT device operation for purposes of detecting undesired behavior in the operation of the IoT device. As another example, the context aware event aggregation engine 310 can filter out features that would cause model instability (e.g., features that give mixed signals or random noise).

The aggregated event transmission engine 312 is intended to represent an engine that functions to transmit aggregated events to a remote system for purposes of determining undesired behavior in the operation of an IoT device. The aggregated event transmission engine 312 can transmit event metadata of aggregated events to a remote system for purposes of determining undesired behavior in the operation of an IoT device. For example, the aggregated event transmission engine 312 can transmit event metadata of aggregated session events occurring at an IoT device for purposes of detecting undesired behavior in the operation of the IoT device. The aggregated event transmission engine 312 can transmit aggregated events to a remotely implemented portion of an applicable system for detecting undesired behavior in operation of an IoT device based on context, such as the context aware IoT device undesired behavior detection systems described in this paper. The aggregated event transmission engine 312 can transmit aggregated events to a remote system implemented in the cloud.

In an example of operation of the example context aware IoT event aggregation system 302 shown in FIG. 3, the IoT device context determination engine 304 determines a context of an IoT device in operation. In the example of operation of the example system shown in FIG. 3, the event determination engine 306 determines events occurring at the IoT device during the operation of the IoT device. Further, in the example system shown in FIG. 3, the event aggregation rules datastore 308 stores event aggregation rules data indicating event aggregation rules for controlling aggregation of events occurring at an IoT device. In the example system shown in FIG. 3, the context aware event aggregation engine 310 aggregates the events determined by the event determination engine 306 according to the event aggregation rules based on the context of the IoT device in operation, as determined by the IoT device context determination engine 304. Additionally, in the example of operation of the example system shown in FIG. 3, the aggregated event transmission engine 312 transmits event metadata of the aggregated events to a remote system for use in detecting undesired behavior in the operation of the IoT device.

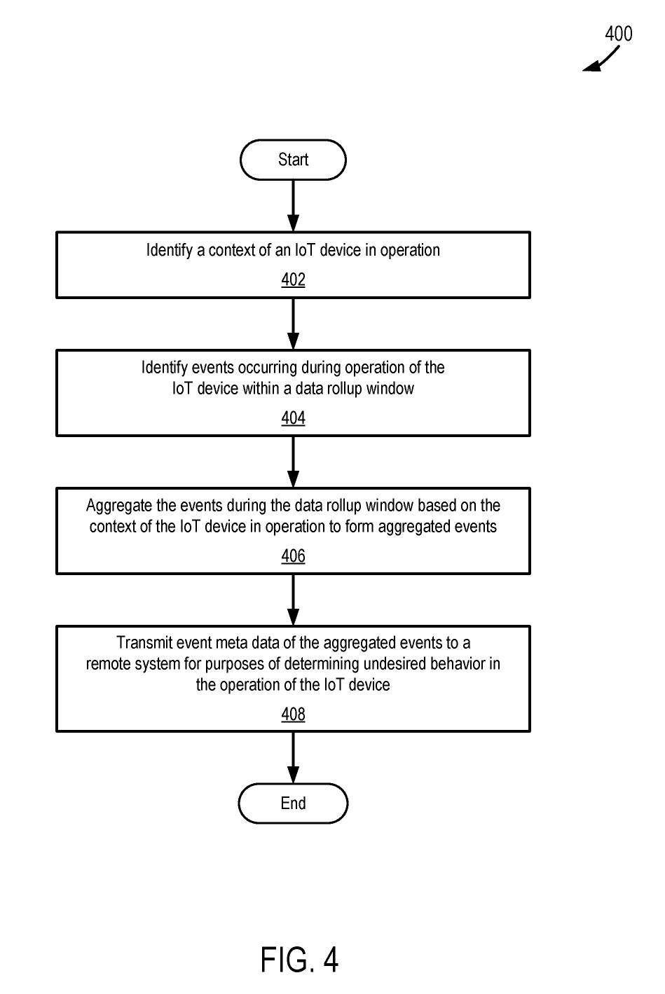

FIG. 4 depicts a flowchart 400 of an example of a method for aggregating events occurring at an IoT device based on context for purposes of detecting undesired behavior in the operation of the IoT device. The flowchart 400 begins at module 402, where a context of an IoT device in operation is identified. An applicable engine for identifying a context of an IoT device in operation, such as the IoT device context determination engines described in this paper, can determine a context of an IoT device in operation. A context of an IoT device can be determined based on identified events occurring at the IoT device during operation. For example, an identification of an IoT device can be determined from data packets transmitted to and from the IoT device. Additionally, a context of an IoT device can be determined based on input received from a user. For example, a user can register a device as a thermostat or CT scanner manufactured by a specific manufacturer.

The flowchart 400 continues to module 404, where events occurring during operation of the IoT device within a data rollup window are determined. An applicable engine for identifying events occurring during operation of an IoT device, such as the event determination engines described in this paper, can identify events occurring during operation of the IoT device within a data rollup window. Events occurring during operation of the IoT device can be identified using applicable mechanism. For example, data packets transmitted to and from the IoT device during operation of the IoT device can be analyzed to identify events occurring during operation of the IoT device. In identifying events occurring during operation of the IoT device, event metadata can be created indicating the identified events.

The flowchart 400 continues to module 406, where the events are aggregated within the data rollup window based on the context of the IoT device in operation to form aggregated events. An applicable engine for aggregating events based on context, such as the context aware event aggregation engines described in this paper, can aggregate the events within the data rollup window based on the context of the IoT device to form aggregated events. For example, session events occurring at the IoT device can be aggregated together based on the context of the IoT device. In aggregating events, event metadata of the events can be grouped together to indicate the aggregated events.

The flowchart 400 continues to module 408, where event metadata of the aggregated events is transmitted to a remote system for purposes of determining undesired behavior in the operation of the IoT device. An applicable engine for transmitting event metadata of aggregated events, such as the aggregated event transmission engines described in this paper, can transmit event metadata of the aggregated events to a remote system for purposes of determining undesired behavior in the operation of the IoT device. For example, event metadata of the aggregated events can be transmitted to a remote portion of an applicable system for detecting undesired behavior in IoT operation based on context, such as the context aware IoT device undesired behavior detection systems described in this paper.

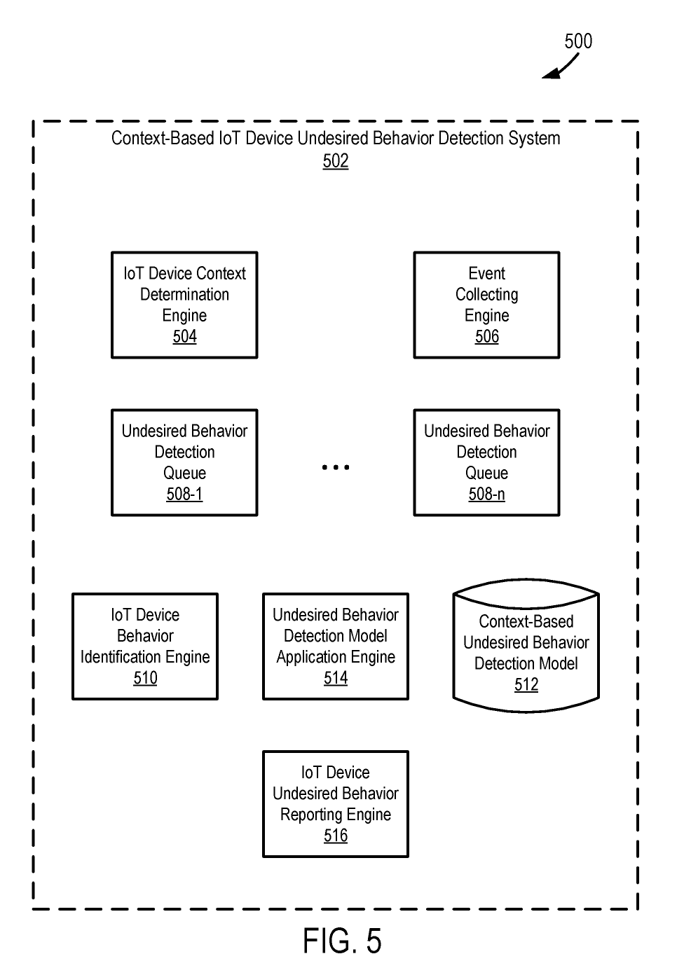

FIG. 5 depicts a diagram 500 of an example context-based IoT device undesired behavior detection system 502. The context-based IoT device undesired behavior detection system 502 is intended to represent a system that functions to detect undesired behavior in operation of an IoT device based on a context of the IoT device in operation. The context-based IoT device undesired behavior detection system 502 can be included as part of an applicable system for detecting undesired behavior in operation of an IoT device based on context, such as the context aware IoT device undesired behavior detection systems described in this paper. Additionally, the context-based IoT device undesired behavior detection system 502 can be implemented remote from an IoT device. For example, the context-based IoT device undesired behavior detection system 502 can be implemented in the cloud remote from an IoT device for which the context-based IoT device undesired behavior detection system 502 detects undesired behavior in operation.

The context-based IoT device undesired behavior detection system 502 functions to receive event metadata of aggregated events occurring during operation of an IoT device for purposes of determining undesired behavior in the operation of the IoT device. For example, the context-based IoT device undesired behavior detection system 502 can receive event metadata of aggregated protocol events of an IoT device in operation from an applicable system for aggregating events such as the context aware IoT device aggregation systems described in this paper. Additionally, the context-based IoT device undesired behavior detection system 502 can collect aggregated events into event buffers based on a context of an IoT device in operation. For example, the context-based IoT device undesired behavior detection system 502 can collect event data of aggregated events including device sensor events into an event buffer specific to processing device sensor events. Further, the context-based IoT device undesired behavior detection system 502 can apply a context-based undesired behavior detection model to events in an event buffer for purposes of identifying undesired behavior in operation of an IoT device. For example, the context-based IoT device undesired behavior detection system 502 can determine a current behavior pattern of an IoT device from aggregated events in an event buffer. Further in the example, the context-based IoT device undesired behavior detection system 502 can compare current behaviors to a normal or otherwise modeled behavior pattern of the IoT device or an associated IoT device, as indicated by a context-based undesired behavior detection model to determine undesired behavior in the operation of the IoT device.

The example context-based IoT device undesired behavior detection system 502 shown in FIG. 5 includes an IoT device context determination engine 504, an event collecting engine 506, event buffer 508-1 to event buffer 508-n (hereinafter referred to as “event buffers 508”), an IoT device behavior identification engine 510, a context-based undesired behavior detection model datastore 512, an undesired behavior detection model application engine 514, and an IoT device undesired behavior reporting engine 516. The IoT device context determination engine 504 is intended to represent an engine that functions to determine contexts of an IoT device, such as the IoT device context determination engines described in this paper. The IoT device context determination engine 504 can determine a context of an IoT device based on events occurring in the operation of the IoT device. For example, if an IoT device is experiencing a number of streaming events, then the IoT device context determination engine 504 can determine a streaming application is executing at the IoT device. Additionally, the IoT device context determination engine 504 can determine a context of an IoT device based on received user input. For example, a user can register a device as a home security system manufactured by a specific manufacturer and the IoT device context determination engine 504 can determine the context of the device is a home security system manufactured by the specific manufacturer.

The event collecting engine 506 is intended to represent an engine that functions to collect aggregated events into event buffers for purposes of detecting undesired behavior in operation of an IoT device. In collecting aggregated events into event buffers, the event collecting engine 506 can add event metadata of the aggregated events into a specific event buffer. For example, the event collecting engine 506 can collect aggregated protocol events of an IoT device into an event buffer by adding event metadata indicating the aggregated protocol events into the event buffer. In collecting aggregated events, the event collecting engine 506 can receive event metadata of aggregated events.

In a specific implementation, the event collecting engine 506 functions to collect aggregated events into an event buffer based on a context of an IoT device when the aggregated events occurred. For example, if a thermostat is operating to raise the temperature in a room, then the event collecting engine 506 can collect events of the thermostat in operation to raise the temperature into an event buffer specific to devices controlling temperature. Further, the event collecting engine 506 can collect aggregated events into an event buffer based on whether the events are one or a combination of device sensor events, session events, application events, user events, protocol events, and status events. For example, if aggregated events are application events, then the event collecting engine 506 can collect the aggregated events into an event buffer specific to processing application events for purposes of identifying undesired behavior in operation of an IoT device.

The event buffers 508 are intended to represent buffers used in processing events for purposes of identifying undesired behavior in the operation of an IoT device. The event buffers 508 can each be specific to a different context of an IoT device. For example, a first event buffer can be specific to IoT devices of a specific type. Additionally, the event buffers 508 can be specific to one or a combination of device sensor events, session events, application events, user events, protocol events, and status events. For example, a first event buffer can be used in processing streaming events while a second event buffer can be used in processing application events for purposes of identifying undesired behavior in operation of an IoT device. The event buffers 508 can be configured to form a pipeline of event buffers. For example, a first event buffer can be logically positioned above a second event buffer to cause aggregated events to pass from the first event buffer to the second event buffer after the events are processed in the first event buffer.

In a specific implementation, the event buffers 508 function to receive event metadata for events aggregated together. The event buffers 508 can collect event metadata of aggregated events for purposes of analyzing the events to determine undesired behavior in operation of an IoT device. For example, the event buffers 508 can collect received event metadata of aggregated events in an order that the event metadata is received for purposes of analyzing the events to identify undesired behavior in the operation of an IoT device.

The IoT device behavior identification engine 510 is intended to represent an engine that functions to determine behaviors of an IoT device in operation to determine undesired behavior in the operation of an IoT device. The IoT device behavior identification engine 510 can determine behaviors of an IoT device through neural network-based learning. For example, the IoT device behavior identification engine 510 can identify DNS names that appear random from a volume DNS query through neural network-based learning. Additionally, the IoT device behavior identification engine 510 can determine behaviors of an IoT device using state transition learning. For example, the IoT device behavior identification engine 510 can identify behaviors of an IoT device in operation from states of an IoT device for events and transitions between events in the operation of the IoT device. The IoT device behavior identification engine 510 can identify behaviors that form behavior patterns that are either benign or malicious. A malicious behavior pattern can be an anomaly from a benign behavior pattern. For example, if a behavior pattern, as determined by the IoT device behavior identification engine 510, indicates an IoT device is under a flood attack different from its normal benign behavior pattern, then the IoT device can be exhibiting malicious behavior.

In a specific implementation, the IoT device behavior identification engine 510 functions to determine behaviors of an IoT device based on events occurring in the operation of the IoT device and collected in event buffers. More specifically, the IoT device behavior identification engine 510 can determine events in operation of an IoT device by analyzing event metadata of aggregated events in event buffers. For example, the IoT device behavior identification engine 510 can determine an IoT device communicated with a specific source based on event metadata of aggregated events in an event buffer. In another example, the IoT device behavior identification engine 510 can determine an IoT device had a streaming application executing on it by analyzing event metadata of aggregated events occurring at the IoT device and collected into event buffers. The IoT device behavior identification engine 510 can identify behaviors of an IoT device in operation by analyzing aggregated events in an order that the events are collected in an event buffer.

The context-based undesired behavior detection model datastore 512 is intended to represent a datastore that functions to store context-based undesired behavior detection model data indicating context-based undesired behavior detection models for use in detecting undesired behavior in IoT device operation. Context-based undesired behavior detection model data stored in the context-based undesired behavior detection model datastore 512 can indicate either or both normal and abnormal behavior patterns of an IoT device in operation. For example, context-based undesired behavior detection model data stored in the context-based undesired behavior detection model datastore 512 can indicate remote systems an IoT device communicates with as part of its regular behavior pattern for purposes of detecting undesired behavior in the behavior of the IoT device.

In a specific implementation, the context-based undesired behavior detection model datastore 512 functions to store context-based undesired behavior detection models maintained in a common language. Specifically, a context-based undesired behavior detection model stored in the context-based undesired behavior detection model datastore 512 can be built in one language, e.g. Python, and then translated into a common language. For example, a context-based undesired behavior detection model stored in the context-based undesired behavior detection model datastore 512 can include descriptions of normal, e.g. benign, behavior of an IoT device, written in a common language such as java script object notation (hereinafter referred to “JSON”). A context-based undesired behavior detection model stored in the context-based undesired behavior detection model datastore 512 can be written offline based on events occurring in historical data and then imported into the context-based undesired behavior detection model datastore 512 for use in detecting undesired behavior in operation of an IoT device.

In a specific implementation, a context-based undesired behavior detection model stored in the context-based undesired behavior detection model datastore 512 includes personality description labels for describing undesired behavior capable of being detected through application of a model. Specifically, a context-based undesired behavior detection model stored in the context-based undesired behavior detection model datastore 512 can include personality description labels for use in describing undesired behavior exhibited by an IoT device in operation. A personality description label can include applicable data for describing undesired behavior exhibited by an IoT device in operation. A personality description label can include specific deviations in behavior (anomalous behavior) from normal behavior of an IoT device and what is causing the IoT device to operate according to the deviations in behavior from the normal behavior. For example, a personality description label included as part of a context-based undesired behavior detection model stored in the context-based undesired behavior detection model datastore 512 can include that if an IoT device is repeatedly receiving data from the same source, then the IoT device is under a flood attack. Machine learning approach, protocol, usage pattern, ID, manufacturer, MAC address, etc. can be used to classify and label devices.

The undesired behavior detection model application engine 514 is intended to represent an engine that functions to determine undesired behavior in operation of an IoT device based on a context of the IoT device. The undesired behavior detection model application engine 514 can determine undesired behavior in operation of an IoT device by applying a context-based undesired behavior detection model to determined behaviors of an IoT device. For example, the undesired behavior detection model application engine 514 can apply a context-based undesired behavior detection model to determine deviations from a normal behavior pattern or a benign behavior pattern of an IoT device to determine undesired behavior in operation of the IoT device. The undesired behavior detection model application engine 514 can apply a context-based undesired behavior detection model to behaviors exhibited by an IoT device as determined from aggregated events collected in an event buffer. For example, the undesired behavior detection model application engine 514 can apply a context-based undesired behavior detection model to streaming behaviors of an IoT device as determined from aggregated streaming events to determine undesired behavior in operation of the IoT device.

In a specific implementation, the undesired behavior detection model application engine 514 functions to select a context-based undesired behavior detection model to apply for purposes of determining undesired behavior in operation of an IoT device. The undesired behavior detection model application engine 514 can determine a context-based undesired behavior detection model to apply based on an event buffer in which aggregated events are collected. For example, if behaviors are determined from aggregated events in a specific event buffer, then the undesired behavior detection model application engine 514 can select a specific context-based undesired behavior detection model associated with the specific event buffer. Further, the undesired behavior detection model application engine 514 can select a context-based undesired behavior detection model to apply based on either or both a context of an IoT device and contexts of associated IoT devices. For example, if an IoT device is manufactured by a specific manufacturer, then the undesired behavior detection model application engine 514 can select a context-based undesired behavior detection model created by modeling behavior of devices manufactured by the specific manufacturer. Additionally, the undesired behavior detection model application engine 514 can select a context-based undesired behavior detection model based on whether behaviors are determined from events that are one or a combination of device sensor events, session events, application events, user events, protocol events, and status events. For example, if the undesired behavior detection model application engine 514 is applying a model to behaviors of an IoT device determined from session events, then the undesired behavior detection model application engine 514 can select a context-based undesired behavior detection model created from session events occurring at an IoT device.

In a specific implementation, the undesired behavior detection model application engine 514 functions to label detected undesired behavior in IoT device behavior. The undesired behavior detection model application engine 514 can label detected undesired behavior in IoT device behavior according to personality description labels included as part of a context-based undesired behavior detection model. For example, the undesired behavior detection model application engine 514 can label behavior of an IoT device as being characteristic of a device subject to a malware attack using personality description labels included as part of a context-based undesired behavior detection model.

The IoT device bad personality reporting engine 516 is intended to represent an engine that functions to report detected undesired behavior in operation of an IoT device. The IoT device bad personality reporting engine 516 can generate and send a bad personality report including applicable data related to detected undesired behavior in operation of an IoT device. Specifically, the IoT device bad personality reporting engine 516 can generate and send a bad personality report including one or a combination of observed behaviors or events corresponding to undesired behavior in operation of an IoT device, descriptions of detected undesired behavior, and labels of detected undesired behavior. For example, the IoT device bad personality reporting engine 516 can generate and send a bad personality report indicating an IoT device was exhibiting undesired behavior in operation characteristic of a device under attack. In another example, the IoT device bad personality reporting engine 516 can generate and send a bad personality report indicating whether an IoT device is exhibiting a benign or a malicious behavior pattern.

In a specific implementation, the IoT device bad personality reporting engine 516 functions to generate and send an undesirable behavior report based on either or both a degree to which an IoT device is exhibiting undesired behavior in its behaviors during operation and a number of instances in which the IoT device is exhibiting undesired behavior in its behavior during operation. For example, if an IoT device is only deviating slightly from normal behavior of an IoT device, e.g. either its own normal behavior or normal behavior of associated IoT devices, then the IoT device undesirable behavior reporting engine 516 can refrain from generating and sending an undesirable behavior report.

In an example of operation of the example context-based IoT device undesired behavior detection system 502 shown in FIG. 5, the IoT device context determination engine 504 determines a context of an IoT device in operation. In the example of operation of the example system shown in FIG. 5, the event collecting engine 506 receives aggregated events occurring in the operation of the IoT device. Further, in the example of operation of the example system shown in FIG. 5, the event collecting engine 506 collects the aggregated events in one of the event buffers 508 based on the determined context of the IoT device. In the example of operation of the example system shown in FIG. 5, the IoT device behavior identification engine 510 determines behaviors of the IoT device in operation based on the aggregated events in the event buffer. Additionally, in the example of operation of the example system shown in FIG. 5, the undesired behavior detection model application engine 514 detects undesired behavior in operation of the IoT device by applying a context-based undesired behavior detection model to the behaviors determined by the IoT device behavior identification engine 510. In the example of operation of the example system shown in FIG. 5, the IoT device undesirable behavior reporting engine 516 generates and sends an undesirable behavior report based on detected undesired behavior in the operation of the IoT device found by the undesired behavior detection model application engine 514.

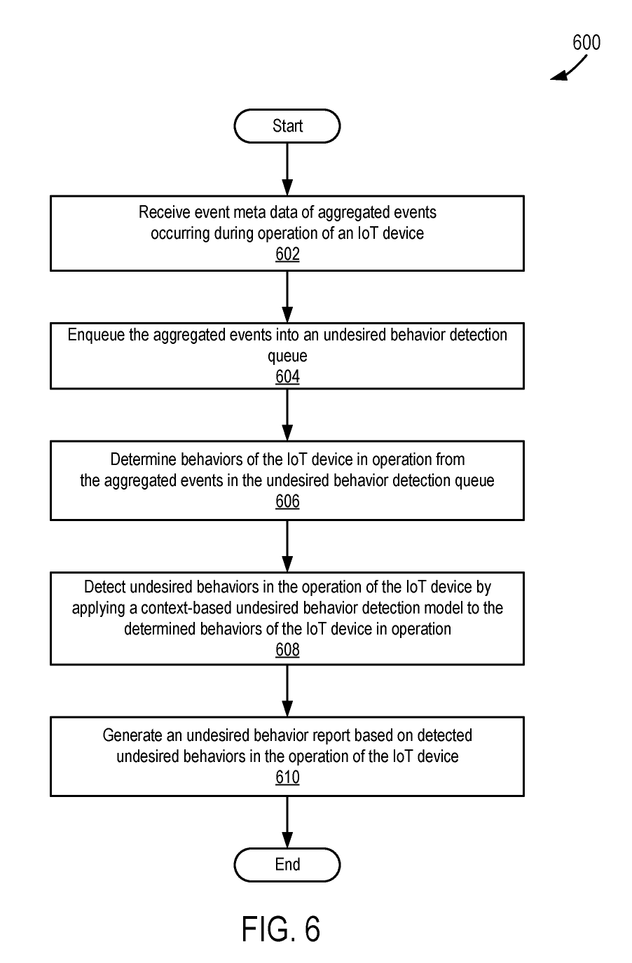

FIG. 6 depicts a flowchart 600 of an example of a method for detecting undesired behavior in operation of an IoT device using aggregated events occurring in the operation of the IoT device. The flowchart 600 begins at module 602, where event metadata of aggregated events occurring during operation of an IoT device is received. An applicable engine for receiving event metadata of aggregated events, such as the event collecting engines described in this paper, can receive event metadata of aggregated events. Event metadata of aggregated events can be received from an applicable system for aggregating events based on a context of an IoT device, such as the context aware IoT event aggregation systems described in this paper.

The flowchart 600 continues to module 604, where the aggregated events are collected into an event buffer. An applicable engine for collecting events occurring during operation of an IoT device, such as the event collecting engines described in this paper, can collect the aggregated events into an event buffer. The aggregated events can be collected into an event buffer based on a context of the IoT device. For example, the aggregated events can be collected into an event buffer associated with a specific user operating the device when the aggregated events occurred. Additionally, the aggregated events can be collected into an event buffer based on whether the events are one or a combination of device sensor events, session events, application events, user events, protocol events, and status events.

The flowchart 600 continues to module 606, where behaviors of the IoT device in operation are determined from the aggregated events in the event buffer. An applicable engine for determining behaviors of an IoT device, such as the IoT device behavior identification engines described in this paper can determine behaviors of the IoT device in operation from the aggregated events in the event buffer. For example, states of an IoT device in operation corresponding to behaviors of the IoT device in operation can be determined from either or both the events themselves or transitions between the events.

The flowchart 600 continues to module 608, where undesired behavior in the operation of the IoT device are detected by applying a context-based undesired behavior detection model to the determined behaviors of the IoT device in operation. An applicable engine for applying a context-based undesired behavior detection model, such as the undesired behavior detection model application engines described in this paper, can apply a context-based undesired behavior detection model to the determined behaviors of the IoT device to identify undesired behavior in the operation of the IoT device. For example, determined behaviors of the IoT device can be compared to normal behavior patterns, e.g. benign behavior patterns, of the IoT device or associated IoT devices to identify undesired behavior in the operation of the IoT device. A context-based undesired behavior detection model to apply to the determined behaviors can be selected based on a context of the IoT device. Further, a context-based undesired behavior detection model to apply to the determined behaviors can be selected based on whether the aggregated events are one or a combination of device sensor events, session events, application events, user events, protocol events, and status events.

The flowchart 600 continues to module 610, where an undesirable behavior report is generated based on detected undesired behavior in the operation of the IoT device. An applicable engine for generating and sending an undesirable behavior report based on detected undesired behavior in operation of IoT devices, such as the IoT device undesirable behavior reporting engines described in this paper, can generate an undesirable behavior report based on detected undesired behavior in the operation of the IoT device. An undesirable behavior report can include a description of how the IoT device is operating to cause the detection of undesired behavior in the operation of the IoT device. Additionally, an undesirable behavior report can include labels of detected undesired behavior in the operation of the IoT device.

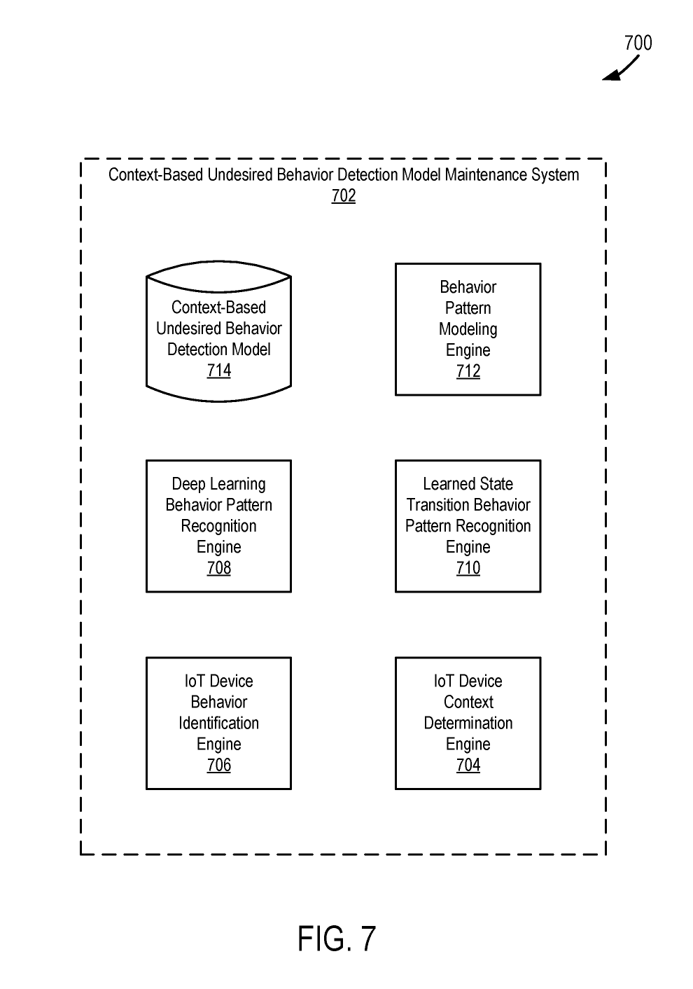

FIG. 7 depicts a diagram 700 of an example context-based undesired behavior detection model maintenance system 702. The context-based undesired behavior detection model maintenance system 702 is intended to represent a system that maintains context-based undesired behavior detection models for purposes of detecting undesired behavior in the operation of an IoT device. The context-based undesired behavior detection model maintenance system 702 can be included as part of an applicable system for detecting undesired behavior in IoT device operation based on context, such as the context aware IoT device undesired behavior detection systems described in this paper. Additionally, the context-based undesired behavior detection model maintenance system 702 can be implemented remote from an IoT device. For example, the context-based undesired behavior detection model maintenance system 702 can be implemented in the cloud remote from an IoT device whose behavior is monitored to determine undesired behavior in operation.

The context-based undesired behavior detection model maintenance system 702 functions to generate and update context-based undesired behavior detection models based on behaviors of IoT devices. In maintaining context-based undesired behavior detection models based on behaviors, the context-based undesired behavior detection model maintenance system 702 can determine behaviors of IoT devices in operation. For example, the context-based undesired behavior detection model maintenance system 702 can determine behaviors of IoT devices in operation based on aggregated events occurring during operation of the IoT devices. Additionally, the context-based undesired behavior detection model maintenance system 702 can recognize behavior patterns from determined behaviors of IoT devices in maintaining a context-based undesired behavior detection model. For example, the context-based undesired behavior detection model maintenance system 702 can recognize normal behavior patterns, e.g. benign behavior patterns, of an IoT device in operation and build or update a context-based undesired behavior detection model based on the recognized normal behavior patterns of the IoT device.

In a specific implementation, the context-based undesired behavior detection model maintenance system 702 functions to maintain context-based undesired behavior detection models offline. In maintaining context-based undesired behavior detection models offline the context-based undesired behavior detection model maintenance system 702 can maintain the models at specific times regardless of current operation of IoT devices. For example, the context-based undesired behavior detection model maintenance system 702 can update context-based undesired behavior detection models every month. Further a context-based undesired behavior detection model maintained by the context-based undesired behavior detection model maintenance system 702 can be shared between different users. For example, if a first user's IoT device is used to create a context-based undesired behavior detection model, then the context-based undesired behavior detection model maintenance system 702 can share the model with another user unrelated to the first user.

In a specific implementation, the context-based undesired behavior detection model maintenance system 702 functions to maintain a context-based undesired behavior detection model included as part of either or both a personality of an IoT device and a profile of a group of IoT devices. For example, the context-based undesired behavior detection model maintenance system 702 can maintain a context-based undesired behavior detection model for instances when an IoT device is streaming data, included as part of a personality of the IoT device, based on streaming events occurring during operation of the IoT device. In another example, the context-based undesired behavior detection model maintenance system 702 can maintain a context-based undesired behavior detection model, included as part of a profile of a group of IoT devices grouped together based on a shared context, for session events occurring during operation of the IoT devices.

The example context-based undesired behavior detection model maintenance system 702 shown in FIG. 7 includes an IoT device context determination engine 704, an IoT device behavior identification engine 706, a deep learning behavior pattern recognition engine 708, a learned state transition behavior pattern recognition engine 710, a behavior pattern modeling engine 712, and a context-based undesired behavior detection model datastore 714. The IoT device context determination engine 704 is intended to represent an engine that functions to determine a context of an IoT device, such as the IoT device context determination engines described in this paper. The IoT device context determination engine 704 can determine a context of an IoT device based on events occurring in the operation of the IoT device. For example, if an IoT device is communicating with a web server, then the IoT device context determination engine 704 can determine a web browser is executing at the IoT device. Additionally, the IoT device context determination engine 704 can determine a context of an IoT device based on received user input. For example, a user can specify allowed users for an IoT device and the IoT device context determination engine 704 can determine a non-allowed user is attempting to operation the IoT device.

The IoT device behavior identification engine 706 is intended to represent an engine that functions to identify behaviors of an IoT device in operation, such as the IoT device behavior identification engines described in this paper. The IoT device behavior identification engine 706 can determine behaviors of an IoT device based on events occurring in the operation of the IoT device and collected in event buffers. More specifically, the IoT device behavior identification engine 706 can determine events in operation of an IoT device by analyzing event metadata of aggregated events in event buffers. For example, the IoT device behavior identification engine 706 can determine an IoT device received data used in executing a specific application from a remote source based on event metadata of aggregated events in an event buffer. In another example, the IoT device behavior identification engine 706 can determine an IoT device had a streaming application executing on it by analyzing event metadata of aggregated events occurring at the IoT device and collected into event buffers.

The deep learning behavior pattern recognition engine 708 is intended to represent an engine that functions to recognize behavior patterns of IoT devices in operation using deep learning. The deep learning behavior pattern recognition engine 708 can recognize behavior patterns of IoT devices by applying deep learning to identified behaviors of an IoT device. For example, if an IoT device in executing a streaming application receives data at a specific frequency, then the deep learning behavior pattern recognition engine 708 can use deep learning to associate the behavior of data being received at a specific frequency with the behavior pattern of the streaming application executing at the IoT device. The deep learning behavior pattern recognition engine 708 can use either or both supervised or unsupervised deep learning to recognize behavior patterns of IoT devices in operation. For example, a user can provide specific behavior patterns associated with specific malware executing at an IoT device and the deep learning behavior pattern recognition engine 708 can learn additional behavior patterns associated with the specific malware infecting an IoT device based on observed behaviors of the IoT device and specific behavior patterns provided by the user. In another example, the deep learning behavior pattern recognition engine 708 can train an artificial neural network to recognize DNS names which appear random but are actually malicious.

In a specific implementation, using deep learning to recognize behavior patterns of IoT devices, the deep learning behavior pattern recognition engine 708 functions to generate a neural network graph of behavior patterns using neural network-based learning. More specifically, the deep learning behavior pattern recognition engine 708 can generate a neural network graph of behavior patterns of an IoT device operating with known or unknown malware using neural network-based learning. For example, if malware does a port scan, indicated by a first behavior pattern, and does a DNS query within an hour, indicated by a second behavior pattern, then the deep learning behavior pattern recognition engine 708 can generate a neural network graph connecting the first behavior pattern and the second behavior pattern to the behavior pattern that an IoT device is infected with malware.

In a specific implementation, the deep learning behavior pattern recognition engine 708 can use deep learning to identify recognized behavior patterns of IoT devices in operation as either or both normal or abnormal behavior patterns of the IoT devices. For example, the deep learning behavior pattern recognition engine 708 can identify a recognized behavior pattern as a malicious behavior pattern. In another example, the deep learning behavior pattern recognition engine 708 can identify a recognized behavior pattern as a benign behavior pattern, e.g. it regularly occurs at an IoT device in operation.

The learned state transition pattern recognition engine 710 is intended to represent an engine that functions to recognize behavior patterns of IoT devices in operation using learned state transition-based learning. The learned state transition pattern recognition engine 710 can recognize behavior patterns of IoT device in operation using learned state transition-based learning according to identified behaviors occurring during operation of an IoT device. More specifically, the learned state transition pattern recognition engine 710 can apply learned state transition-based learning to events occurring during operation of an IoT device. For example, the learned state transition pattern recognition engine 710 can define sets of states of an IoT device corresponding to events and transitions between events occurring in the operation of the IoT device. Further in the example, the learned state transition pattern recognition engine 710 can define a state of an IoT device in operation as being under a malware attack when specific events occur at the IoT device. A state defined by the learned state transition pattern recognition engine 710 can include variances in events and transitions that when met still indicate an IoT device is at the state.

In a specific implementation, the learned state transition pattern recognition engine 710 functions to maintain a state transition graph. A state transition graph can include connected states defined for an IoT device in operation through state transition-based learning. For example, a state transition graph can connect a first state of a port scan being done to a second state of a DNS query being performed within an hour of the port scan, which is indicative of the state of malware executing at an IoT device. Further in the example, a state transition graph can connect the first state of the port scan occurring to the second state of the DNS query being performed to the state of the malware executing at the IoT device as part of a recognized behavior pattern of an IoT device.

In a specific implementation, the learned state transition pattern recognition engine 710 can use deep learning to identify recognized behavior patterns of IoT devices in operation as either or both normal or abnormal behavior patterns of the IoT devices. For example, the learned state transition pattern recognition engine 710 can identify a recognized behavior pattern as a malicious behavior pattern. In another example, the learned state transition pattern recognition engine 710 can identify a recognized behavior pattern as a benign behavior pattern, e.g. it regularly occurs at an IoT device in operation.

In a specific implementation, the deep learning behavior pattern recognition engine 708 and the learned state transition behavior pattern recognition engine 710 operate together to recognize behavior patterns of IoT devices. In operating together to recognize behavior patterns of IoT devices the deep learning behavior pattern recognition engine 708 and the learned state transition behavior pattern recognition engine 710 can apply corresponding deep learning behavior pattern recognition and learned state transition-based learning pattern recognition to observed behaviors until a behavior pattern for the observed behaviors is identified. For example, if observed behaviors fail to conform to a recognized behavior pattern, e.g. as indicated through a neural network graph or a state transition graph, then either or both the deep learning behavior pattern recognition engine 708 and the learned state transition behavior pattern recognition engine 710 can update corresponding models, e.g. the neural network graph or the state transition graph, to include a behavior pattern including the observed behaviors.

The behavior pattern modeling engine 712 is intended to represent an engine that functions to maintain context-based undesired behavior detection models. In maintaining a context-based undesired behavior detection model, the behavior pattern modeling engine 712 can add recognized behavior patterns, both malicious and benign, to a context-based undesired behavior detection model. In maintaining a context-based undesired behavior detection model, the behavior pattern modeling engine 712 can generate and update a context-based undesired behavior detection model. For example, the behavior pattern modeling engine 712 can update a context-based undesired behavior detection model to include newly discovered normal behavior patterns of an IoT device in operation. In another example, if a behavior pattern previously identified as benign has been identified as malicious, e.g. deviating from a benign behavior pattern, then the behavior pattern modeling engine 712 can update a context-based undesired behavior detection model to indicate the behavior pattern is malicious. The behavior pattern modeling engine 712 can maintain context-based undesired behavior detection models based on behavior patterns of IoT devices recognized through an applicable technique. For example, the behavior pattern modeling engine 712 can maintain context-based undesired behavior detection models based on behavior patterns recognized through either or both deep learning behavior pattern recognition and learned state transition behavior pattern recognition.

In a specific implementation, the behavior pattern modeling engine 712 functions to maintain context-based undesired behavior detection models based on determined contexts of IoT devices. In maintaining context-based undesired behavior detection models based on contexts of IoT devices, the behavior pattern modeling engine 712 can associate a context-based undesired behavior detection model with one or a plurality of contexts of an IoT device. For example, if a context-based undesired behavior detection model was created using recognized behavior patterns of a specific type of IoT device, then the behavior pattern modeling engine 712 can associate the model with the specific type of IoT device. Further, in maintaining context-based undesired behavior detection models based on contexts of IoT devices, the behavior pattern modeling engine 712 can associate specific behavior patterns within the model with contexts of IoT devices. For example, if a behavior pattern was formed from events observed at an IoT device when the IoT device was executing a web browser, then the behavior pattern modeling engine 712 can associate the behavior pattern with the context of executing a web browser. Further, the behavior pattern modeling engine 712 can associate a context-based undesired behavior detection model or behavior patterns in the model with one or a combination of device sensor events, session events, application events, user events, protocol events, and status events. For example, if a behavior pattern in a model was recognized based on session events, then the behavior pattern modeling engine 712 can associate the model with session events.

In a specific implementation, the behavior pattern modeling engine 712 functions to maintain a context-based undesired behavior detection model as part of either or both a personality of an IoT device and a profile of a group of IoT devices. For example, the behavior pattern modeling engine 712 can include a context-based undesired behavior detection model maintained using recognized behavior patterns of a specific IoT device as part of a personality for the IoT device. In another example, the behavior pattern modeling engine 712 can include a context-based undesired behavior detection model maintained using recognized behavior patterns of a specific IoT device as part of a profile of a group of IoT devices including the specific IoT device.

In a specific implementation, the behavior pattern modeling engine 712 functions to maintain a context-based undesired behavior detection model in a first language and generate a description of the undesired behavior detection model in a common language, as included as part of the model. For example, the behavior pattern modeling can describe recognized behavior patterns in a context-based undesired behavior detection model in JSON. In another example, the behavior pattern modeling engine 712 can write undesirable behavior description labels in a common language, e.g. in JSON, for use in labeling potential undesired behavior corresponding to recognized behavior patterns. As a result, users are able to interpret why an IoT device is behaving abnormally rather than just simply being informed simply that the IoT device is behaving abnormally. Further, the behavior pattern modeling engine 712 can use an ontology to generate a description of a context-based undesired behavior detection model. For example, the behavior pattern modeling engine 712 can use an ontology of known and unknown malware to associate the known and unknown malware with recognized behavior patterns and subsequently include a description of the known and unknown malware in a description of the model.

The context-based undesired behavior detection model datastore 714 is intended to represent a datastore that functions to store context-based undesired behavior detection model data, such as the context-based undesired behavior detection model datastores described in this paper. Context-based undesired behavior detection model data stored in the context-based undesired behavior detection model datastore 714 can be maintained by an applicable engine for maintaining context-based undesired behavior detection models based on recognized behavior patterns of IoT devices in operation, such as the behavior pattern modeling engines described in this paper. Context-based undesired behavior detection model data stored in the context-based undesired behavior detection model datastore 714 can indicate context-based undesired behavior detection models, contexts associated with context-based undesired behavior detection models, descriptions of context-based undesired behavior detection models, e.g. written in a common language, and undesirable behavior description labels included as part of a context-based undesired behavior detection model.

In an example of operation of the example context-based undesired behavior detection model maintenance system 702 shown in FIG. 7, the IoT device context determination engine 704 determines a context of an IoT device in operation. In the example of operation of the example system shown in FIG. 7, the IoT device behavior identification engine 706 determines behaviors of an IoT device in operation. Further, in the example of operation of the example system shown in FIG. 7, the deep learning behavior pattern recognition engine 708 recognizes behavior patterns of an IoT device in operation through deep learning machine learning using the behaviors identified by the IoT device behavior identification engine 706. In the example of operation of the example system shown in FIG. 7, the learned state transition behavior pattern recognition engine 710 recognized behavior patterns of the IoT device in operation through learned state transition-based learning using the behaviors identified by the IoT device behavior identification engine 706. Additionally, in the example of operation of the example system shown in FIG. 7, the behavior pattern modeling engine 712 maintains a context-based undesired behavior detection model based on the behavior patterns recognized by the deep learning behavior pattern recognition engine 708 and the learned state transition behavior pattern recognition engine 710.

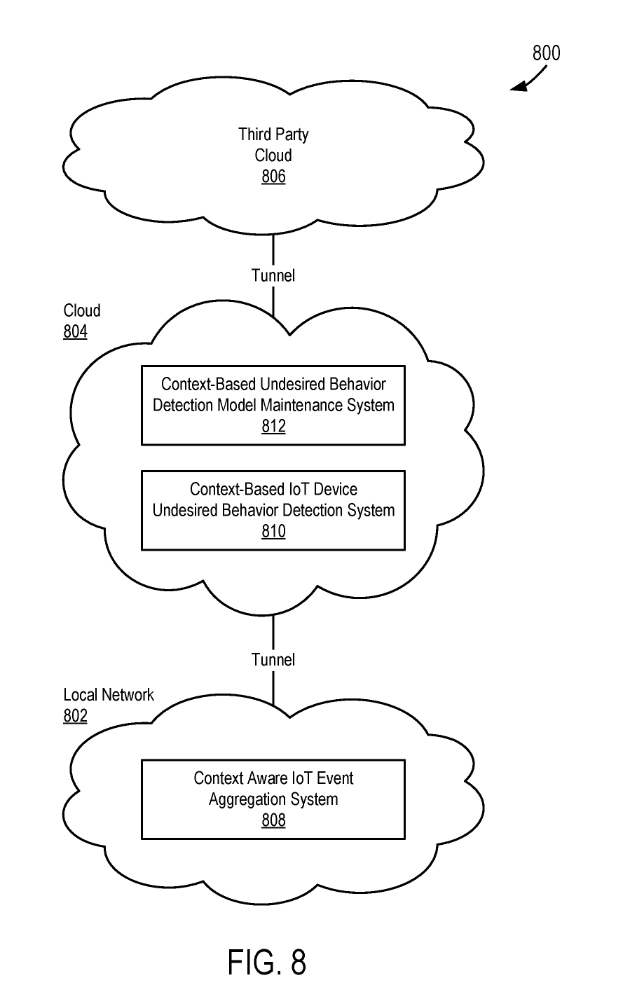

FIG. 8 depicts a diagram 800 of an example of a system for determining undesired behavior of IoT devices in operation. The system shown in the example of FIG. 8 includes a local network 802, a cloud 804, and a third party cloud 806. The local network 802 is intended to represent a network formed by at least one IoT device and a local appliance.

In the example of FIG. 8, the local network 802 includes a context aware IoT event aggregation system 808. The context aware IoT event aggregation system 808 is intended to represent a system that functions to aggregate events for purposes of detecting undesired behavior in operation of IoT devices, such as the context aware IoT aggregation systems described in this paper. The context aware IoT event aggregation system 808 can be implemented as part of a local appliance forming part of the local network 802. In being implemented as part of a local appliance, the context aware IoT event aggregation system 808 can locally aggregate events for purposes of determining undesired behavior in operation of IoT devices.

In the example system shown in FIG. 8, the cloud 804 includes a context-based IoT device undesired behavior detection system 810 and a context-based undesired behavior detection model maintenance system 812. The context-based IoT device undesired behavior detection system 810 is intended to represent a system that functions to detect undesired behavior in operation of an IoT device based on context, such as the context-based IoT device undesired behavior detection systems described in this paper. The context-based undesired behavior detection model maintenance system 812 is intended to represent a system that functions to maintain context-based undesired behavior detection models for purposes of detecting undesired behavior in operation of an IoT device, such as the context-based undesired behavior detection model maintenance system described in this paper. The cloud 804 can be specific to a private entity. The context-based IoT device undesired behavior detection system 810 can receive event metadata of aggregated events through VPN tunnels from the context aware IoT device aggregation system 808 implemented at the local network 802. The context-based IoT device undesired behavior detection system 810 can use received event metadata of aggregated events to detect undesired behavior in operation of an IoT device.

In the example system shown in FIG. 8, the third party cloud 806 is intended to represent a cloud that receives context-based undesired behavior detection models through VPN tunnels. The third party cloud 806 receives context-based undesired behavior detection model data indicating context-based undesired behavior detection models through VPN tunnels from the context-based undesired behavior detection model maintenance system 812 implemented at the cloud 804. The third party cloud 806 can be associated with or used by a third party management system for managing IoT devices.

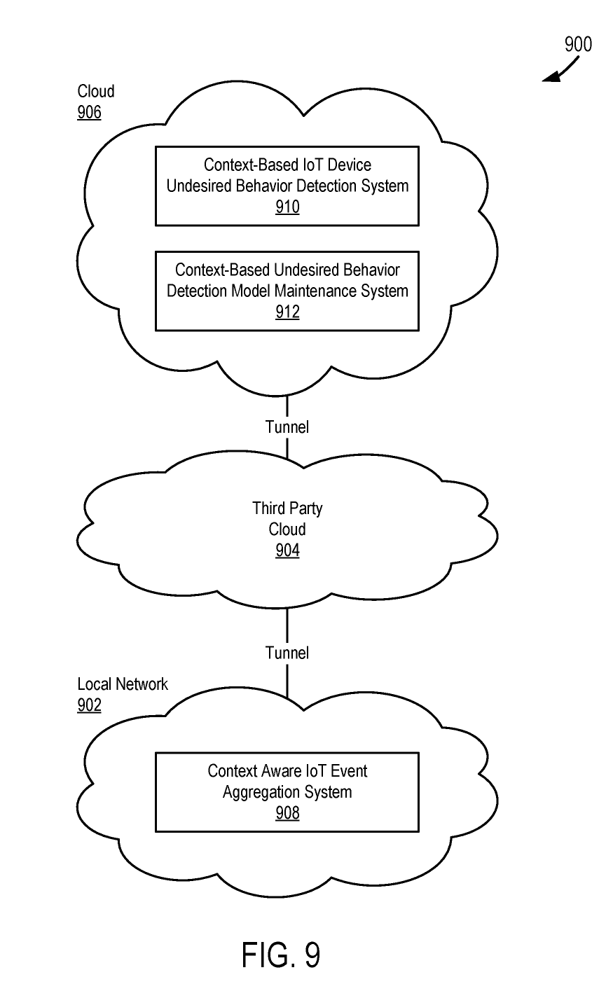

FIG. 9 depicts a diagram 900 of another example of a system for identifying undesired behavior in operation of an IoT device. The system shown in the example of FIG. 9 includes a local network 902, a third party cloud 904, and a cloud 906. The local network 902 is intended to represent a network formed by at least one IoT device and a local appliance. The local network 902 includes a context aware IoT event aggregation system 908. The context aware IoT event aggregation system 908 is intended to represent a system that functions to aggregate events for purposes of detecting undesired behavior in operation of IoT devices, such as the context aware IoT aggregation systems described in this paper. The context aware IoT event aggregation system 908 can be implemented as part of a local appliance forming part of the local network 902. In being implemented as part of a local appliance, the context aware IoT event aggregation system 908 can locally aggregate events for purposes of determining undesired behavior in operation of IoT devices.

In the system shown in the example of FIG. 9, the third party cloud 904 receives event metadata from the context aware IoT event aggregation system 908 implemented at the local network 902. The third party cloud 904 can be associated with or used by a third party management system for managing IoT devices.

In the example system shown in FIG. 9, the cloud 906 includes a context-based IoT device undesired behavior detection system 910 and a context-based undesired behavior detection model maintenance system 912. The context-based IoT device undesired behavior detection system 910 is intended to represent a system that functions to detect undesired behavior in operation of an IoT device based on context, such as the context-based IoT device undesired behavior detection systems described in this paper. The context-based undesired behavior detection model maintenance system 912 is intended to represent a system that functions to maintain context-based undesired behavior detection models for purposes of detecting undesired behavior in operation of an IoT device, such as the context-based undesired behavior detection model maintenance system described in this paper. The context-based IoT device undesired behavior detection system 910 can receive event metadata, through VPN tunnels from the third party cloud 904, which are received at the third party cloud 904 from the context aware IoT event aggregation system 908 implemented at the local network 902. The context-based IoT device undesired behavior detection system 910 can use event metadata received through VPN tunnels from the third party cloud 904 to identify undesired behavior in operation of an IoT device.

The context-based undesired behavior detection model maintenance system 912 can send maintained context-based undesired behavior detection models back to the third party cloud 904 through VPN tunnels. The context-based IoT device undesired behavior detection system 910 can send undesirable behavior reports back to the third party cloud 904 through VPN tunnels.

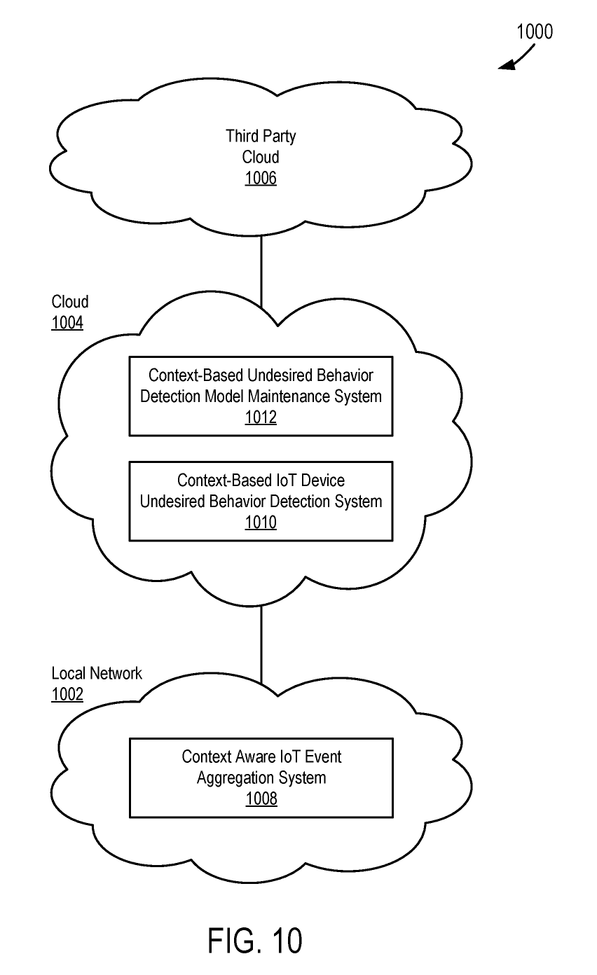

FIG. 10 depicts a diagram 1000 of an example of a system for determining undesired behavior of IoT devices in operation. The system shown in the example of FIG. 10 includes a local network 1002, a cloud 1004, and a third party cloud 1006. The local network 1002 is intended to represent a network formed by at least one IoT device and a local appliance.

In the example of FIG. 10, the local network 1002 includes a context aware IoT event aggregation system 1008. The context aware IoT event aggregation system 1008 is intended to represent a system that functions to aggregate events for purposes of detecting undesired behavior in operation of IoT devices, such as the context aware IoT aggregation systems described in this paper. The context aware IoT event aggregation system 1008 can be implemented as part of a local appliance forming part of the local network 1002. In being implemented as part of a local appliance, the context aware IoT event aggregation system 1008 can locally aggregate events for purposes of determining undesired behavior in operation of IoT devices.

In the example system shown in FIG. 10, the cloud 1004 includes a context-based IoT device undesired behavior detection system 1010 and a context-based undesired behavior detection model maintenance system 1012. The context-based IoT device undesired behavior detection system 1010 is intended to represent a system that functions to detect undesired behavior in operation of an IoT device based on context, such as the context-based IoT device undesired behavior detection systems described in this paper. The context-based undesired behavior detection model maintenance system 1012 is intended to represent a system that functions to maintain context-based undesired behavior detection models for purposes of detecting undesired behavior in operation of an IoT device, such as the context-based undesired behavior detection model maintenance system described in this paper. The cloud 1004 can be specific to a private entity. The context-based IoT device undesired behavior detection system 1010 can receive event metadata of aggregated events from the context aware IoT event aggregation system 1008 implemented at the local network 1002. The context-based IoT device undesired behavior detection system 1010 can use received event metadata of aggregated events to detect undesired behavior in operation of an IoT device.

In the example system shown in FIG. 10, the third party cloud 1006 is intended to represent a cloud that receives context-based undesired behavior detection models. The third party cloud 1006 receives context-based undesired behavior detection model data indicating context-based undesired behavior detection models from the context-based undesired behavior detection model maintenance system 1012 implemented at the cloud 1004. The third party cloud 1006 can be associated with or used by a third party management system for managing IoT devices.

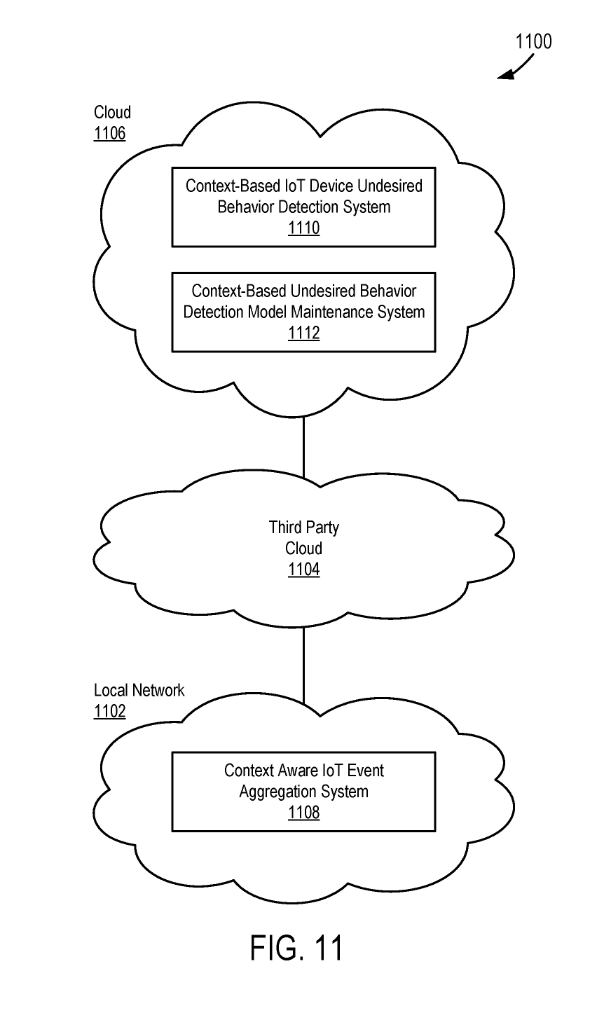

FIG. 11 depicts a diagram 1100 of another example of a system for identifying undesired behavior in operation of an IoT device. The system shown in the example of FIG. 11 includes a local network 1102, a third party cloud 1104, and a cloud 1106. The local network 1102 is intended to represent a network formed by at least one IoT device and a local appliance. The local network 1102 includes a context aware IoT event aggregation system 1108. The context aware IoT event aggregation system 1108 is intended to represent a system that functions to aggregate events for purposes of detecting undesired behavior in operation of IoT devices, such as the context aware IoT aggregation systems described in this paper. The context aware IoT event aggregation system 1108 can be implemented as part of a local appliance forming part of the local network 1102. In being implemented as part of a local appliance, the context aware IoT event aggregation system 1108 can locally aggregate events for purposes of determining undesired behavior in operation of IoT devices.

In the system shown in the example of FIG. 11, the third party cloud 1104 receives event metadata from the context aware IoT event aggregation system 108 implemented at the local network 1102. The third party cloud 1104 can be associated with or used by a third party management system for managing IoT devices.

In the example system shown in FIG. 1, the cloud 1106 includes a context-based IoT device undesired behavior detection system 1110 and a context-based undesired behavior detection model maintenance system 1112. The context-based IoT device undesired behavior detection system 1110 is intended to represent a system that functions to detect undesired behavior in operation of an IoT device based on context, such as the context-based IoT device undesired behavior detection systems described in this paper. The context-based undesired behavior detection model maintenance system 1112 is intended to represent a system that functions to maintain context-based undesired behavior detection models for purposes of detecting undesired behavior in operation of an IoT device, such as the context-based undesired behavior detection model maintenance system described in this paper. The context-based IoT device undesired behavior detection system 1110 can receive event metadata, from the third party cloud 1104, which are received at the third party cloud 1104 from the context aware IoT event aggregation system 1108 implemented at the local network 1102. The context-based IoT device undesired behavior detection system 1110 can use event metadata received from the third party cloud 1104 to identify undesired behavior in operation of an IoT device.

The context-based undesired behavior detection model maintenance system 1112 can send maintained context-based undesired behavior detection models back to the third party cloud 1104. The context-based IoT device undesired behavior detection system 1110 can send undesirable behavior reports back to the third party cloud 1104.

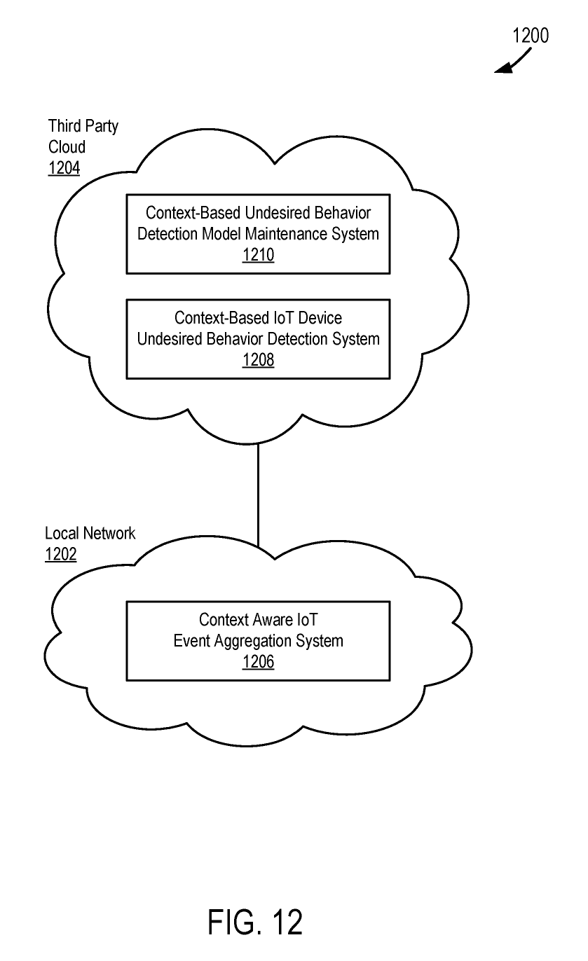

FIG. 12 depicts a diagram 1200 of another example of a system for determining undesired behavior in operation of an IoT device. The system shown in the example of FIG. 12 includes a local network 1202 and a third party cloud 1204. The local network 1202 includes a context aware IoT event aggregation system 1206. The context aware IoT event aggregation system 1206 is intended to represent a system that functions to aggregate events for purposes of detecting undesired behavior in operation of an IoT device, such as the context aware IoT event aggregation systems described in this paper.

In the system shown in the example of FIG. 12, the third party cloud 1204 includes a context-based IoT device undesired behavior detection system 1208 and a context-based undesired behavior detection model maintenance system. The context-based IoT device undesired behavior detection system 1208 is intended to represent an applicable system for detecting undesired behavior in operation of an IoT device, such as the context-based IoT device undesired behavior detection systems described in this paper. The context-based IoT device undesired behavior detection system 1208 can detect undesired behavior in operation of an IoT device based on event metadata received from the context aware IoT event aggregation system 1206. The context-based undesired behavior detection model maintenance system 1210 is intended to represent a system that functions to maintain a context-based undesired behavior detection model for use in detecting undesired behavior in operation of an IoT device, such as the context-based undesired behavior learning detection model maintenance systems described in this paper.

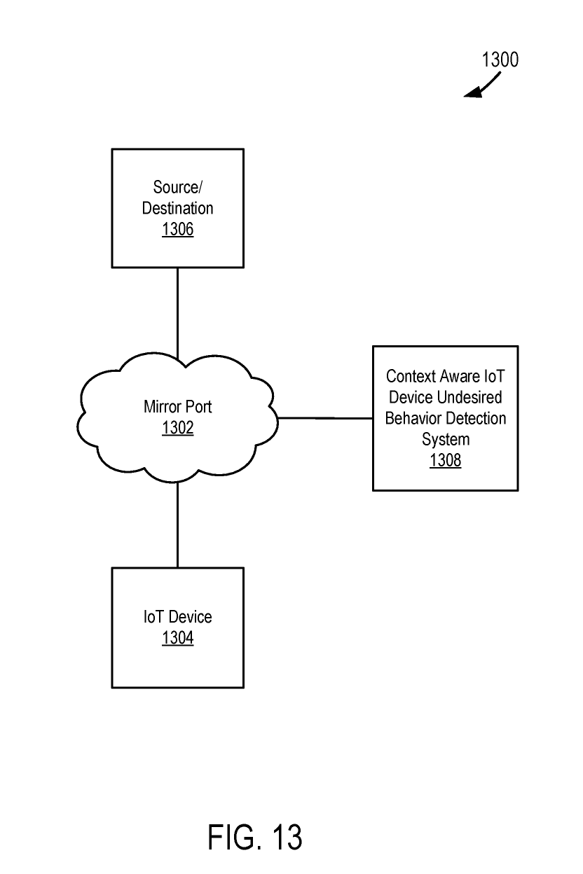

FIG. 13 depicts a diagram 1300 of an example of a system for detecting undesired behavior in IoT device operation through a mirror point. The system shown in the example of FIG. 13 includes a mirror port 1302, an IoT device 1304, a source/destination 1306, and a context aware IoT device undesired behavior detection system 1308. The mirror port 1302 is intended to represent a device that functions to perform port mirroring on another port. The mirror port 1302 can be used to obtain data packets transmitted to and from IoT devices without disrupting the flow of the data packets. The mirror port 1302 can be implemented as part of switches or other applicable networking devices. For example, the IoT device 1304 could be operationally connected to a network of switches in the mirror port 1302 through a gateway (not shown) and the context aware IoT device undesired behavior detection system 1308 could be operationally connected to the network of switches through a switch or other network device that sees (ideally, all of) the IoT device communications.

Additionally, the mirror port 1302 can be implemented on network devices in a LAN of IoT devices, or on network devices in a WAN of IoT devices. For example, the mirror port 1302 can be implemented as part of a local router in an enterprise network of IoT devices. In being implemented as part of the local router in an enterprise network, the mirror port 1302 can be used to obtain data packets transmitted between IoT devices in the enterprise network, e.g. intranetwork traffic. Also, the context aware IoT device undesired behavior detection system 1308 could be implemented on a gateway of the mirror port 1302 through which the IoT devices 1304 are coupled.

In the example of FIG. 13, the IoT device 1304 is intended to represent a device that includes wired or wireless interfaces through which the IoT device 1304 can send and receive data over wired and wireless connections. The IoT device 1304 can include unique identifiers which can be used in the transmission of data through a network. Unique identifiers of the IoT device 1304 can include identifiers created in accordance with Internet Protocol version 4 (hereinafter referred to as “IPv4”), or identifiers created in accordance with Internet Protocol version 6 (hereinafter referred to as “IPv6”), of which both protocol versions are hereby incorporated by reference.

In the example of FIG. 13, the source/destination 1306 is intended to represent a system accessible by IoT devices through, e.g., a WAN. For example, the source/destination 1306 can be a system that an IoT device communicates with over the Internet. Alternatively, the source/destination 1306 can be a system or device within a LAN of an IoT device. For example, the source/destination 1306 can be another IoT device in a LAN over which an IoT device communicates.

In the example of FIG. 13, the context aware IoT device undesired behavior detection system 1308 is intended to represent a system that functions to identify undesired behavior in operation of an IoT device, such as the context aware IoT device undesired behavior detection systems described in this paper. The context aware IoT device undesired behavior detection system 1308 functions to determine undesired behavior in operation of an IoT device based on event metadata generated from data packets transmitted to and from the IoT devices. The context aware IoT device undesired behavior detection system 1308 can obtain event metadata through a mirror port, without interrupting the flow of the data packets between sources and destinations.

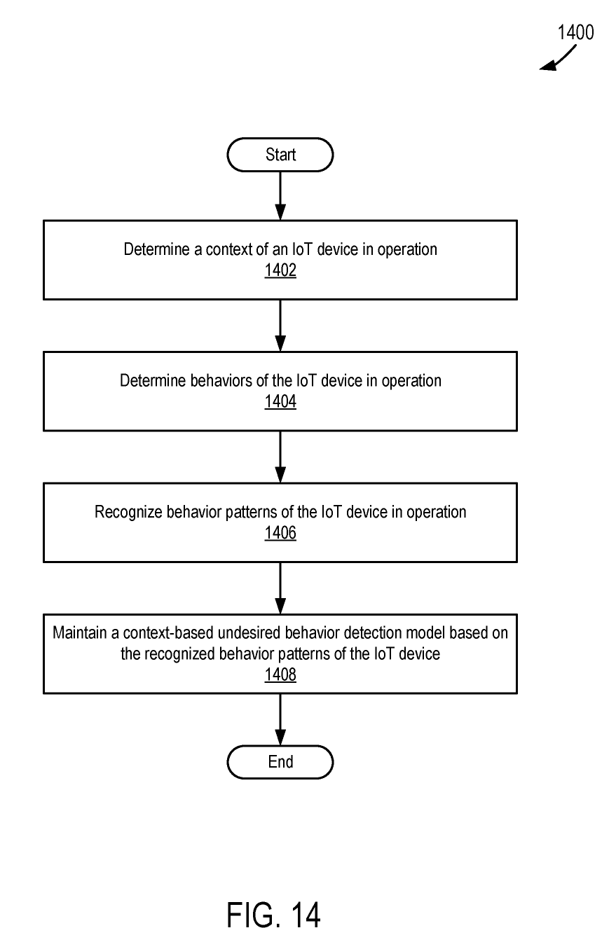

FIG. 14 depicts a flowchart 1400 of an example of a method for maintaining a context-based undesired behavior detection model for use in determining undesired behavior in operation of an IoT device. The flowchart 1400 begins at module 1402, where a context of an IoT device in operation is determined. An applicable engine for determining a context of an IoT device in operation, such as the IoT device context determination engines described in this paper, can determine a context of an IoT device in operation. A context of an IoT device can be determined based on events occurring in the operation of the IoT device. For example, if an IoT device is communicating with a web server, then it can be determined a web browser is executing at the IoT device. Additionally, a context of an IoT device can be determined based on received user input. For example, a user can specify allowed users for an IoT device and an IoT device context can be determined indicating a non-allowed user is attempting to operation the IoT device.

The flowchart 1400 continues to module 1404, where behaviors of the IoT device in operation are determined. An applicable engine for determining behaviors of an IoT device in operation, such as the IoT device behavior identification engines described in this paper, can determine behaviors of the IoT device in operation. Behaviors of the IoT device in operation can be determined based on aggregated events occurring in the operation of the IoT device. More specifically, behaviors of an IoT device in operation can be determined from event metadata of aggregated events collected in an event buffer.

The flowchart 1400 continues to module 1406, where behavior patterns of the IoT device in operation are recognized. Behavior patterns of the IoT device in operation can be recognized by an applicable engine for using deep learning machine learning to recognize behavior patterns of an IoT device, such as the deep learning behavior pattern recognition engines described in this paper. Additionally, behavior patterns of the IoT device in operation can be recognized by an applicable engine for using learned state transition-based learning to recognize behavior patterns of an IoT device, such as the learned state transition pattern recognition engines described in this paper. Behavior patterns of the IoT device in operation can be recognized from determined behaviors of the IoT device in operation.

The flowchart 1400 continues to module 1408, where a context-based undesired behavior detection model is maintained based on the recognized behavior patterns of the IoT device. An applicable engine for maintaining context-based undesired behavior detection models, such as the behavior pattern modeling engines described in this paper, can maintain a context-based undesired behavior detection model. A context-based undesired behavior detection model can be maintained based on either or both recognized behavior patterns and contexts of an IoT device in operation.

IoT devices can be characterized as having a personality. A personality can be bad, which means the personality is identifiable as one that belongs to a device that exhibits or has an unacceptable risk to exhibit undesirable behavior. A personality can be good, which means the personality is identifiable as one that belongs to a device that has not and is not expected to exhibit undesirable behavior. Devices can exhibit anomalous behavior, but anomaly detection is a useful tool to determine whether a device is exhibiting undesirable behavior, so anomalous behavior is sometimes associated with undesirable behavior. Over time, anomalous behavior can be indicative of an as-of-yet-unidentified personality. That is, if a device with a first personality exhibits anomalous behavior, it may be possible to define a second personality similar in some ways to the first personality, but for which certain behavior is not anomalous. Similarly, a first personality could be better defined over time to include what was previously anomalous behavior as non-anomalous behavior. Accordingly, it may be desirable to provide a system that can not only classify IoT devices as having various personalities, but also to provide a system that can allow personality to have malleable definitions and that can define new personalities over time.

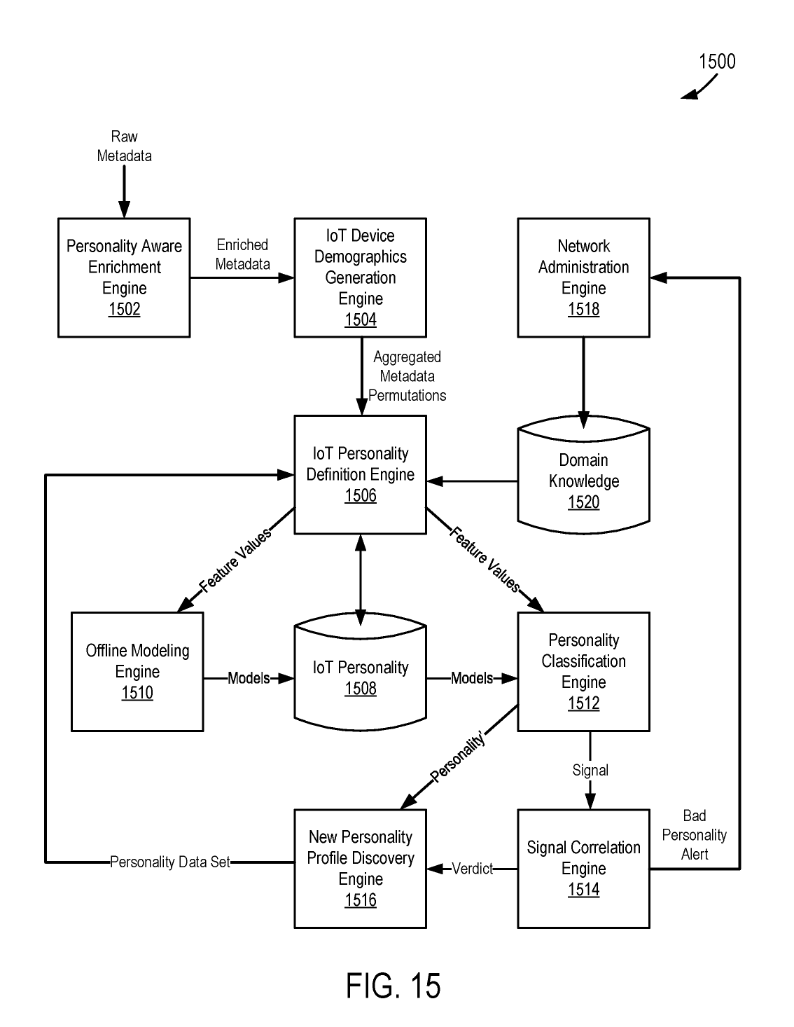

FIG. 15 depicts a diagram 1500 of an example of a IoT device personality management system. The example system shown in FIG. 15 can be included as part of an applicable system for detecting undesired behavior in operation of an IoT device based on context, such as the context aware IoT device undesired behavior detection systems described in this paper. Applicable portions of the system shown in FIG. 15 can be implemented locally with respect to an IoT device, e.g. at a device within a LAN of the IoT device. Additionally, applicable portions of the system shown in FIG. 15 can be implemented remote from an IoT device, e.g. in a cloud.

The example system shown in FIG. 15 includes a personality aware enrichment engine 1502, an IoT device demographics generation engine 1504, an IoT personality definition engine 1506, an IoT personality datastore 1508, an offline modeling engine 1510, a personality classification engine 1512, a signal correlation engine 1514, and a new personality profile discovery engine 1516, a network administration engine 1518, and a domain knowledge datastore 1520. In the context of FIG. 15, personality awareness is more specific than context awareness in the sense that personality implicates an understanding of institutional protocols. An IoT device that “has a personality” indicates the IoT device most closely matches a known personality and at least one of the combination of features that define the personality is associated with an institutional protocol. It should be noted that, for practical purposes, it may be desirable to throw away irrelevant or unstable features to match an IoT device to a personality.

The personality aware enrichment engine 1502 is intended to represent an engine that functions to enrich raw event metadata received based on operation of an IoT device. The personality aware enrichment engine 1502 can receive raw metadata in the form of data packets or portions of data packets transmitted to and from an IoT device in operation of the IoT device. In enriching raw event metadata, the personality aware enrichment engine 1502 can identify an IoT device and assign a context to the IoT device.

The IoT device demographics generation engine 1504 is intended to represent an engine that receives enriched metadata to maintain demographics of IoT devices including the IoT device. The IoT device demographics generation engine 1504 receives the enriched metadata from the personality aware enrichment engine 1502. In maintaining demographics of IoT devices based on enriched metadata, the IoT device demographics generation engine 1504 can establish profiles of groups of IoT devices. For example, the IoT device demographics generation engine 1504 can group together IoT devices that share a common context together to form a profile of a group of the IoT devices. Additionally, in maintaining demographics of IoT devices, the IoT device demographics generation engine 1504 can aggregate and create permutations of the enriched metadata to generate aggregated metadata permutations. For example, the IoT device demographics generation engine 1504 can group together all enriched metadata related to streaming events at the IoT device together to generate aggregated metadata permutations.

The IoT personality definition engine 1506 is intended to represent an engine that functions to define a personality of the IoT device. The IoT personality definition engine 1506 can define a personality of the IoT device by generating and updating IoT personality data stored in the IoT personality datastore 1508. Additionally, the IoT personality definition engine 1506 can define a personality of the IoT device using aggregated metadata permutations received from the IoT device demographics generation engine 1504. More specifically, the IoT personality definition engine 1506 can identify feature values indicating behaviors of the IoT device in operation based on aggregated metadata permutations received from the IoT device demographics generation engine 1504.

The offline modeling engine 1510 is intended to represent an engine that functions to build a context-based undesired behavior detection model for use in detecting undesired behavior in the operation of the IoT device. The offline modeling engine 1510 can build a context-based undesired behavior detection model based on feature values indicating behaviors of the IoT device in operation, as determined by the IoT personality definition engine 1506. Additionally, the offline modeling engine 1510 can use an applicable machine learning mechanism to recognize behavior patterns in the feature values to build the context-based undesired behavior detection model. For example, the offline modeling engine 1510 can use either or both learned state transition-based learning and deep learning to identify behavior patterns of the IoT in operation for purposes of maintaining a context-based undesired behavior detection model.

The personality classification engine 1512 is intended to represent an engine that functions to apply a context-based undesired behavior detection model to feature values for purposes of detecting undesired behavior in the operation of the IoT device. The personality classification engine 1512 can apply a context-based undesired behavior detection model maintained by the offline modeling engine 1510 to feature values of the IoT device identified by the IoT personality definition engine 1506. In applying the model to feature values, the personality classification engine 1512 generate a signal comparing actual behaviors of the IoT device in operation to modeled behaviors of the IoT device.

The signal correlation engine 1514 is intended to represent an engine that functions to generate and send undesirable behavior alerts. The signal correlation engine 1514 can generate and send undesirable behavior alerts based on actual behaviors of the IoT device in operation to modeled behaviors of the IoT device, as received from the personality classification engine 1512. The signal correlation engine 1514 can send an undesirable behavior alert indicating how the IoT device deviated from normal behavior patterns, e.g. benign behavior patterns, in exhibiting undesired behavior in operation.

The new personality profile discovery engine 1516 is intended to represent an engine that functions to identify a personality profile of the IoT device. The new personality profile discovery engine 1516 can detect whether an IoT personality profile exists for the IoT device based on one or a combination of raw metadata received at the personality aware enrichment engine 1502, enriched raw metadata received at the IoT device demographics generation engine 1504, aggregated metadata permutation received at the IoT personality definition engine 1506, and feature values determined by the IoT personality definition engine 1506. The new personality profile discovery engine 1516 can inform the IoT personality definition engine 1506 whether an IoT personality profile exists for the IoT device for purposes of defining the IoT personality for the IoT device.

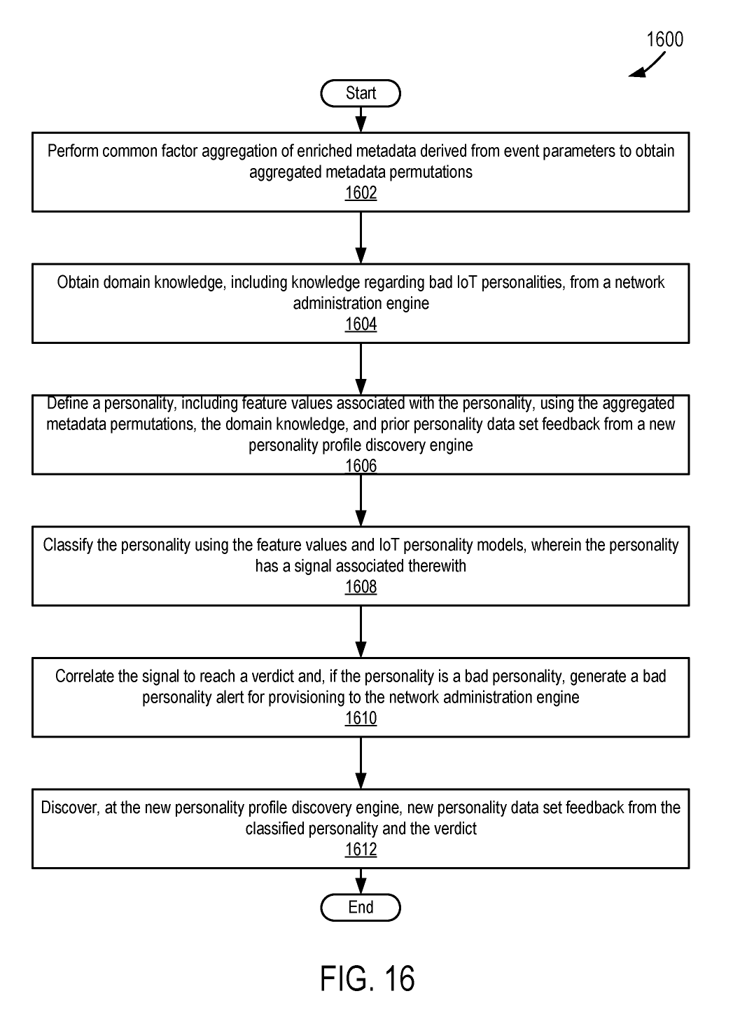

FIG. 16 depicts a flowchart 1600 of an example of a method of IoT device personality management. The flowchart 1600 starts at module 1602 with performing common factor aggregation of enriched metadata derived from event parameters to obtain aggregated metadata permutations. An example of an engine that can perform module 1602 is the IoT device demographics generation engine 1504 of FIG. 15.

The flowchart 1600 continues to module 1604 with obtaining domain knowledge, including knowledge regarding bad IoT personalities, from a network administration engine. An example of an engine that can perform module 1604 is the IoT personality definition engine 1504 of FIG. 15, which obtains domain knowledge from the domain knowledge datastore 1520.

The flowchart 1600 continues to module 1606 with defining a personality, including feature values associated with the personality, using the aggregated metadata permutations, the domain knowledge, and prior personality data set feedback from a new personality profile discovery engine. An example of an engine that can perform module 1606 is the IoT personality definition engine 1506 of FIG. 15.

The flowchart 1600 continues to module 1608 with classifying the personality using the feature values and IoT personality models, wherein the personality has a signal associated therewith. An example of an engine that can perform module 1608 is the personality classification engine 1512 of FIG. 15.

The flowchart 1600 continues to module 1610 with correlating the signal to reach a verdict and, if the personality is a bad personality, generate a bad personality alert for provisioning to the network administration engine. An example of an engine that can perform module 1610 is the signal correlation engine 1514 of FIG. 15.

The flowchart 1600 continues to module 1612 with discovering, at the new personality profile discovery engine, new personality data set feedback from the classified personality and the verdict. An example of an engine that can perform module 1612 is the new personality profile discovery engine 1516 of FIG. 15.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A method comprising:
performing common factor aggregation of enriched metadata derived from event parameters to obtain aggregated metadata permutations;
obtaining domain knowledge, including knowledge regarding bad IoT personalities, from a network administration engine;
defining a personality, including data samples associated with the personality, using the aggregated metadata permutations, the domain knowledge, and prior personality data set feedback from a new personality profile discovery engine;
classifying the personality using the data samples and IoT personality models, wherein the personality has a signal associated therewith;
correlating the signal to reach a verdict and, if the personality is a bad personality, providing bad personality feedback associated with the personality to the network administration engine;
discovering, at the new personality profile discovery engine, new personality data set feedback from the classified personality and the verdict.

2. The method of claim 1, wherein the personality is built by mathematically modeling a behavior pattern using the event parameters.

3. The method of claim 1, comprising enriching raw metadata to obtain the enriched metadata.

4. The method of claim 1, wherein the aggregated metadata permutations are part of a common methodological framework of IoT device demographics.

5. The method of claim 1, wherein the aggregated metadata permutations are aggregated over a data rollup window that varies based on the context of the IoT device.

6. The method of claim 1, comprising:
performing offline modeling using the data samples;
updating the IoT personality models with the offline modeling.

7. The method of claim 1, wherein the data samples are first data samples, comprising:
performing offline modeling using second data samples;
classifying the personality using the first data samples, the second data samples, and the IoT personality models.

8. The method of claim 1, comprising: recognizing behavior patterns of the IoT device using either or both learned state-transition learning and deep learning.

9. The method of claim 1, comprising: recognizing behavior patterns of the IoT device using either or both a neural network graph of past behavior patterns of the IoT device recognized using deep learning and a state transition graph of the past behavior patterns of the IoT device recognized using learned state-transition learning.

10. The method of claim 1, comprising:
computing a degree of risk of undesirable behavior;
generating the bad personality alert if the degree of risk of undesirable behavior exceeds an actionable intelligence threshold.

11. The method of claim 1, wherein at least some of the domain knowledge comes from at least one of security research and human expertise, comprising: using the new personality set feedback to enhance IoT personality models and create new personality models that describe bad behaviors.

12. A system comprising:
a network administration engine;
a domain knowledge datastore, coupled to the network administration engine, that stores domain knowledge, including knowledge regarding bad IoT personalities received from the network administration engine;
an IoT device demographics generation engine configured to perform common factor aggregation of enriched metadata derived from event parameters to obtain aggregated metadata permutations;
an IoT personality definition engine, coupled to the IoT device demographics generation engine and the domain knowledge datastore, configured to define a personality, including data samples associated with the personality, using the aggregated metadata permutations, the domain knowledge, and prior personality data set feedback;
an IoT personality datastore, coupled to the IoT personality definition engine, that stores IoT personality models;
a personality classification engine, coupled to the IoT personality definition engine and the IoT personality datastore, configured to classify the personality using the data samples and IoT personality models, wherein the personality has a signal associated therewith;
a signal correlation engine, coupled to the personality classification engine, configured to correlate the signal to reach a verdict and, if the personality is a bad personality, provide bad personality feedback associated with the personality to the network administration engine;
a new personality profile discovery engine, coupled to the personality classification engine and the signal correlation engine, configured to discover new personality data set feedback from the classified personality and the verdict for provisioning to the IoT personality definition engine.

13. The system of claim 12, wherein the personality is built by mathematically modeling a behavior pattern using the event parameters.

14. The system of claim 12, comprising a personality aware enrichment engine, coupled to the IoT device demographics engine, configured to enrich raw metadata to obtain the enriched metadata.

15. The system of claim 12, wherein the aggregated metadata permutations are part of a common methodological framework of IoT device demographics.

16. The system of claim 12, wherein the aggregated metadata permutations are aggregated over a data rollup window that varies based on the context of the IoT device.

17. The system of claim 12, comprising an offline modeling engine, coupled to the IoT personality definition engine and the IoT personality datastore, configured to:
perform offline modeling using the data samples;
update the IoT personality datastore with models in conformity with the offline modeling.

18. The system of claim 12, wherein the data samples are first data samples, comprising an offline modeling engine, coupled to the IoT personality definition engine and the IoT personality datastore, configured to:
perform offline modeling using second data samples;
update the IoT personality datastore with models in conformity with the offline modeling.

19. The system of claim 12, wherein the IoT device demographics generation engine uses either or both learned state-transition learning and deep learning.

20. The system of claim 12, wherein the IoT device demographics generation engine uses either or both a neural network graph of past behavior patterns of the IoT device recognized using deep learning and a state transition graph of the past behavior patterns of the IoT device recognized using learned state-transition learning.

21. The system of claim 12, wherein the signal correlation engine is configured to:
compute a degree of risk of undesirable behavior;
generate the bad personality alert if the degree of risk of undesirable behavior exceeds an actionable intelligence threshold.

22. The system of claim 12, wherein at least some of the domain knowledge comes from at least one of security research and human expertise, wherein the IoT personality definition engine uses the new personality set feedback to enhance IoT personality models and create new personality models that describe bad behaviors.

23. A system comprising:
means for performing common factor aggregation of enriched metadata derived from event parameters to obtain aggregated metadata permutations;
means for obtaining domain knowledge, including knowledge regarding bad IoT personalities, from a network administration engine;
means for defining a personality, including data samples associated with the personality, using the aggregated metadata permutations, the domain knowledge, and prior personality data set feedback from a new personality profile discovery engine;
means for classifying the personality using the data samples and IoT personality models, wherein the personality has a signal associated therewith;
means for correlating the signal to reach a verdict and, if the personality is a bad personality, providing bad personality feedback associated with the personality to the network administration engine;
means for discovering, at the new personality profile discovery engine, new personality data set feedback from the classified personality and the verdict.
